(19) United States
(12) Patent Application Publication
(10) Pub. No.: US 2009/0080647 A1
(43) Pub. Date: Mar. 26, 2009

(54) Method and System for Usage of Block Cipher Encryption

(75) Inventors: Itsik Mantin, Shoham (IL); Yaron Sella, Yehud (IL); Erez Waisbard, Or-Yehuda (IL)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: NDS Limited, West Drayton, Middlesex (GB)

(21) Appl. No.: 12/085,393

(22) PCT Filed: Dec. 4, 2006
(86) PCT No.: PCT/IL06/01394

§ 371 Date: Jul. 10, 2008

(30) Foreign Application Priority Data
Dec. 14, 2005 (IL) 172578
Feb. 21, 2006 (IL) 173863
May 21, 2006 (IL) 175802

(51) Int. Cl. H04L 9/06

(52) U.S. Cl. 380/29

(57) ABSTRACT

A block cipher system for encrypting a plurality of blocks from plaintext to ciphertext, each of the blocks being associated with a constant root key, the system including an encryption key module to determine an input key for each of blocks based on a function having a plurality of inputs including the root key and an initialization vector, for a first one of the blocks, and the plaintext of at least one of the blocks which was previously encrypted and the root key, for the blocks other than the first block, and an encryption module to encrypt each of the blocks based on the input key determined for each of the blocks, respectively. Related apparatus and methods also included.

### FIELD OF THE INVENTION

The present invention relates to encryption/decryption, and more particularly, to modes of operation of block ciphers.

### BACKGROUND OF THE INVENTION

Many encryption methods are known in the art. Of the known methods, many methods are block methods where an input plaintext block is altered according to a function that depends on a secret encryption key to obtain an output ciphertext block. One of the inherent properties of block ciphers is the processing of blocks of fixed size, referred herein as the block size. Typically, the block size is smaller than the standard packet size of the communication media to be secured. Two examples for different communication media packet sizes are: (a) TCP/IP communication where the standard packet size is 1.5 Kilobytes, (b) MPEG2/DVB broadcast systems where the standard packet size is 188 bytes. Two examples of different block ciphers having different block sizes are: (a) DES with a block size of 8 bytes, and (b) AES with a block size of 16 bytes.

When the packets that need to be encrypted are longer than the block size, there are several modes of operation for using the block cipher. Some examples of modes of operation include: (1) Electronic Code Book (ECB) mode where each block is encrypted independently of other blocks; (2) Cipher Block Chaining (CBC) mode where each plaintext block is XORed to the ciphertext of the previous block before being encrypted; and (3) Reverse Cipher Block Chaining mode (RCBC) which is like CBC mode except that blocks are processed in reverse order. Chapter 9 of “Applied Cryptography (Second Edition)” by Bruce Schneier, published by John Wiley & Sons, Inc. 1996, surveys various modes of operation of block ciphers. The RCBC mode of operation is described in U.S. Pat. No. 5,799,089. to Kühn, et al.

By way of introduction, in a broadcast system a broadcast Headend typically transmits content to many broadcast clients in the system. In order to prohibit unauthorized access to the content, broadcast content is usually encrypted. Each encryption/decryption key is used for a relatively short period of time (known as the key period), after which it is replaced by a new key. Key replacement is performed in order to protect the broadcast system from key distribution attacks, an attack in which an authorized client distributes the key to a group of unauthorized clients.

Broadcast systems may also be subject to pirate attacks that are addressed to facilitate unauthorized consumption of copyrighted content by simulating the decryption process on general purpose machines, such as a PC.

Therefore, in addition to regular key replacement, the decryption process sometimes includes operations that can be executed efficiently only on specialized hardware. An example of a standard that describes a broadcast system in the field of digital television is the digital video broadcasting (DVB) standard. The block cipher specified by the DVB standard, known as the DVB Common Scrambling Algorithm version 2.0 (DVB CSA 2.0), is indeed software unfriendly.

Pirate simulations of the decryption process may accelerate the processing by changing the flow of operation in the decryption process, such as, by calculating some of the operations in parallel or preprocessing some of the calculations. For example, for a content packet that contains U blocks encrypted with the same key, the key setup operations may be performed in parallel in U decryption engines. Furthermore, the decryption of the U blocks may also be done in parallel. Known modes of operation for block ciphers such as the OFB mode (see chapter 9 of “Applied Cryptography (Second Edition)” by Bruce Schneier, published by John Wiley & Sons, Inc. 1996) prevent parallel decryption. The OFB mode uses the encryption method of the block cipher in both the encryptor and decryptor; in the decryptor the input of the encryption process for block j depends on the output of the encryption process for block j−1. However, all the encryption and decryption processes use the same key, thus the key setup phase can only be performed once.

PCT Published Patent Application WO 01/91466 of NDS Limited describes an interactive television system for decrypting objects based on a user response. It should be noted that the objects are not blocks of packets. The user response is combined with the control word to form an updated control word for decryption purposes. It is readily apparent that the system of WO 01/91466 is not a block cipher system and therefore not relevant to the system of the present invention.

The following references are believed to represent the state of the art:

US Published Patent Application 2002/0076044 of Pires;

Paper entitled “Description of a New Variable-Length Key, 64-Bit Block Cipher (Blowfish)” by B. Schneier published at a conference entitled “Fast Software Encryption”, Cambridge Security Workshop Proceedings (December 1993), Springer-Verlag, 1994, pp. 191-204;

Article entitled “Tweakable Block Ciphers” by Moses Liskov, Ronald L. Rivest and David Wagner published by Laboratory for Computer Science Massachusetts Institute of Technology, Cambridge, Mass. 02139, USA; and

Section 9.40, pages 340-346 of Handbook of Applied Cryptography by A. Menezes, P. van Oorschot and S. Vanstone published by CRC Press, Inc. 1997.

The disclosures of all references mentioned above and throughout the present specification, as well as the disclosures of all references mentioned in those references, are hereby incorporated herein by reference.

### SUMMARY OF THE INVENTION

The present invention seeks to provide an improved block cipher system and mode of operation of block ciphers.

By way of introduction, the system of the present invention, in preferred embodiments thereof, includes modifying the encryption/decryption key, preferably for each block in a packet.

Frequent key modification may slow the encryption/decryption speed. However, on the other hand, frequent key modification typically strengthens the cipher against cryptanalysis. Additionally, frequent key modification may also be beneficial when the cipher is required to be efficient in hardware implementations and inefficient in software implementations. The latter requirement typically arises in broadcasting systems.

The system of the present invention, in preferred embodiments thereof, induces a path of dependencies in the decryption process and thus enforces a sequential flow of computations during the decryption process, prohibiting parallelization and preprocessing. The de-parallelization effect is achieved by frequent key modifications based on one or more previously decrypted plaintext blocks, preferably the last plaintext block to be decrypted. In accordance with the most preferred embodiment of the present invention, the key modification is also based on one or more of the ciphertext blocks and/or a block index or block-counter.

In accordance with another preferred embodiment of the present invention, each block is encrypted/decrypted by a block cipher arrangement including a plurality of block ciphers. Processing by the block cipher arrangement between plaintext and ciphertext is performed such that between the block ciphers there is an intermediate value which is a value between the plaintext and the ciphertext. An input key of at least one of the ciphers is based on one or more intermediate values of a prior block, preferably the last prior processed block.

There is thus provided in accordance with a preferred embodiment of the present invention There is also provided in accordance with still another preferred embodiment of the present invention a block cipher system for encrypting a plurality of blocks from plaintext to ciphertext, each of the blocks being associated with a constant root key, the system including an encryption key module to determine an input key for each of blocks based on a function having a plurality of inputs including the root key and an initialization vector, for a first one of the blocks, and the plaintext of at least one of the blocks which was previously encrypted and the root key, for the blocks other than the first block, and an encryption module to encrypt each of the blocks based on the input key determined for each of the blocks, respectively.

Further in accordance with a preferred embodiment of the present invention the input key for the blocks other than the first block is also based on the initialization vector.

Still further in accordance with a preferred embodiment of the present invention the input key of each of the blocks other than the first block, is also based on the ciphertext of at least one of the blocks which was previously encrypted.

Additionally in accordance with a preferred embodiment of the present invention the input key of the each of the blocks other than the first plaintext block, is also based on the ciphertext of one of the blocks last encrypted.

Moreover in accordance with a preferred embodiment of the present invention the input key of each of the blocks other than the first plaintext block, is also based on the plaintext of one of the blocks last encrypted.

Further in accordance with a preferred embodiment of the present invention each of the blocks has a block index, the input key of each of the blocks also being based on the block index.

Still further in accordance with a preferred embodiment of the present invention the encryption input key module includes a counter module to maintain a block counter of the number of the blocks processed such that the input key of each of the blocks is also based on the block counter.

Additionally in accordance with a preferred embodiment of the present invention the input key of each of the blocks is determined using an exclusive-OR function.

Moreover in accordance with a preferred embodiment of the present invention the input key of each of the blocks is determined using a cryptographic hash function.

There is also provided in accordance with still another preferred embodiment of the present invention a block cipher system for decrypting a plurality of blocks from ciphertext to plaintext, each of the blocks being associated with a constant root key, the system including a decryption key module to determine an input key for each of blocks based on a function having a plurality of inputs including the root key and an initialization vector, for a first one of the blocks, and the plaintext of at least one of the blocks which was previously decrypted and the root key, for the blocks other than the first block, and a decryption module to decrypt each of the blocks based on the input key determined for each of the blocks, respectively.

Further in accordance with a preferred embodiment of the present invention the input key for the blocks other than the first block is also based on the initialization vector.

Still further in accordance with a preferred embodiment of the present invention the input key of each of the blocks other than the first block, is also based on the ciphertext of at least one of the blocks which was previously decrypted.

Additionally in accordance with a preferred embodiment of the present invention the input key of the each of the blocks other than the first plaintext block, is also based on the ciphertext of one of the blocks last decrypted.

Moreover in accordance with a preferred embodiment of the present invention the input key of each of the blocks other than the first plaintext block, is also based on the plaintext of one of the blocks last decrypted.

Further in accordance with a preferred embodiment of the present invention each of the blocks has a block index, the input key of each of the blocks also being based on the block index.

Still further in accordance with a preferred embodiment of the present invention the decryption input key module includes a counter module to maintain a block counter of the number of the blocks processed such that the input key of each of the blocks is also based on the block counter.

Additionally in accordance with a preferred embodiment of the present invention the input key of each of the blocks is determined using an exclusive-OR function.

Moreover in accordance with a preferred embodiment of the present invention the input key of each of the blocks is determined using a cryptographic hash function.

There is also provided in accordance with still another preferred embodiment of the present invention a block cipher system for encrypting a plurality of blocks from plaintext to ciphertext, each of the blocks being associated with a constant root key, the system including an encryption key module to determine an input key for each of blocks based on a function having a plurality of inputs including the root key and an initialization vector, for a first one of the blocks, and the ciphertext of a last encrypted one of the blocks and the plaintext of a last encrypted one of the blocks and the root key, for the blocks other than the first block, and an encryption module to encrypt each of the blocks based on the input key determined for each of the blocks, respectively.

Further in accordance with a preferred embodiment of the present invention each of the blocks has a block index and wherein the input key of each of the blocks is also based on the block index.

Still further in accordance with a preferred embodiment of the present invention the encryption input key module includes a counter module to maintain a block counter of the number of the blocks processed such that the input key of each of the blocks is also based on the block counter.

Additionally in accordance with a preferred embodiment of the present invention the input key of each of the blocks is determined using an exclusive-OR function.

Moreover in accordance with a preferred embodiment of the present invention the input key of each of the blocks is determined using a cryptographic hash function.

There is also provided in accordance with still another preferred embodiment of the present invention a block cipher system for decrypting a plurality of blocks from ciphertext to plaintext, each of the blocks being associated with a constant root key, the system including a decryption key module to determine an input key for each of blocks based on a function having a plurality of inputs including the root key and an initialization vector, for a first one of the blocks, and the ciphertext of a last decrypted one of the blocks and the plaintext of a last decrypted one of the blocks and the root key, for the blocks other than the first block, and a decryption module to decrypt each of the blocks based on the input key determined for each of the blocks, respectively.

Further in accordance with a preferred embodiment of the present invention each of the blocks has a block index, the input key of each of the blocks also being based on the block index.

Still further in accordance with a preferred embodiment of the present invention the decryption input key module includes a counter module to maintain a block counter of the number of the blocks processed such that the input key of each of the blocks is also based on the block counter.

Additionally in accordance with a preferred embodiment of the present invention the input key of each of the blocks is determined using an exclusive-OR function.

Moreover in accordance with a preferred embodiment of the present invention the input key of each of the blocks is determined using a cryptographic hash function.

There is also provided in accordance with still another preferred embodiment of the present invention a block cipher system for encrypting/decrypting a plurality of blocks between plaintext and ciphertext, each of the blocks being associated with a constant root key, the system including an encryption/decryption module including a plurality of block ciphers to jointly encrypt/decrypt between the plaintext and the ciphertext such that, for each of the blocks, between a first pair of the block ciphers there is a first intermediate value which is a value between the plaintext and the ciphertext, at least one of the ciphers performing encryption/decryption based on an input key, and an encryption/decryption key module to determine the input key for each of blocks based on a function having a plurality of inputs including the root key and an initialization vector, for a first one of the blocks, and the first intermediate value of a prior one of the blocks and the root key, for the blocks other than the first block.

Further in accordance with a preferred embodiment of the present invention the encryption/decryption module includes at least three block ciphers such that encrypting/decrypting between the plaintext and the ciphertext is performed jointly by the at least three block ciphers.

Still further in accordance with a preferred embodiment of the present invention between a second pair of the block ciphers, for each of the blocks, there is a second intermediate value which is a value between the plaintext and the ciphertext, the encryption/decryption key module being operative to determine the input key, for the blocks other than the first block, such that one of the inputs of the function also includes the second intermediate value of a prior one of the blocks.

Additionally in accordance with a preferred embodiment of the present invention the prior one block is a last prior-processed one of the blocks.

Moreover in accordance with a preferred embodiment of the present invention each of the blocks has a block index, the input key of each of the blocks also being based on the block index.

Further in accordance with a preferred embodiment of the present invention the encryption/decryption input key module includes a counter module to maintain a block counter of the number of the blocks processed such that the input key of each of the blocks is also based on the block counter.

Still further in accordance with a preferred embodiment of the present invention the input key of each of the blocks is determined using an exclusive-OR function.

Additionally in accordance with a preferred embodiment of the present invention the input key of each of the blocks is determined using a cryptographic hash function.

There is also provided in accordance with still another preferred embodiment of the present invention a method for operating a block cipher to encrypt a plurality of blocks from plaintext to ciphertext, each of the blocks being associated with a constant root key, the method including determining an input key for each of blocks based on a function having a plurality of inputs including the root key and an initialization vector, for a first one of the blocks, and the plaintext of at least one of the blocks which was previously encrypted and the root key, for the blocks other than the first block, and encrypting each of the blocks based on the input key determined for each of the blocks, respectively.

There is also provided in accordance with still another preferred embodiment of the present invention a method for operating a block cipher to decrypt a plurality of blocks from ciphertext to plaintext, each of the blocks being associated with at least one constant root key, the method including determining an input key for each of blocks based on a function having a plurality of inputs including the root key and an initialization vector, for a first one of the blocks, and the plaintext of at least one of the blocks which was previously decrypted and the root key, for the blocks other than the first block, and decrypting each of the blocks based on the input key determined for each of the blocks, respectively.

There is also provided in accordance with still another preferred embodiment of the present invention a method for operating a block cipher to encrypt a plurality of blocks from plaintext to ciphertext, each of the blocks being associated with a constant root key, the method including determining an input key for each of blocks based on a function having a plurality of inputs including the root key and an initialization vector, for a first one of the blocks, and the ciphertext of a last encrypted one of the blocks and the plaintext of a last encrypted one of the blocks and the root key, for the blocks other than the first block, and encrypting each of the blocks based on the input key determined for each of the blocks, respectively.

There is also provided in accordance with still another preferred embodiment of the present invention a method for operating a block cipher for decrypting a plurality of blocks from ciphertext to plaintext, each of the blocks being associated with at least one constant root key, the method including determining an input key for each of blocks based on a function having a plurality of inputs including the root key and an initialization vector, for a first one of the blocks, and the ciphertext of a last decrypted one of the blocks and the plaintext of a last decrypted one of the blocks and the root key, for the blocks other than the first block, and decrypting each of the blocks based on the input key determined for each of the blocks, respectively.

There is also provided in accordance with still another preferred embodiment of the present invention a method for operating a block cipher to encrypt/decrypt a plurality of blocks between ciphertext and plaintext, each of the packets having a plurality of blocks, the packets being associated with at least one constant root key, the method including providing a plurality of block ciphers to jointly encrypt/decrypt between the plaintext and the ciphertext such that, for each of the blocks, between a first pair of the block ciphers there is a first intermediate value which is a value between the plaintext and the ciphertext, determining an input key for each of blocks based on a function having a plurality of inputs including the root key and an initialization vector, for a first one of the blocks, and the first intermediate value of a prior one of the blocks and the root key, for the blocks other than the first block, and performing encryption/decryption for one of the block ciphers based on the input key.

### BRIEF DESCRIPTION OF THE DRAWINGS

The present invention will be understood and appreciated more fully from the following detailed description, taken in conjunction with the drawings in which:

FIG. 1 is a cryptographic process flow diagram of a preferred general mode of operation of a block cipher system constructed and operative in accordance with a preferred embodiment of the present invention;

FIG. 2 is a cryptographic process flow diagram of a most preferred mode of operation of the block cipher system of FIG. 1;

FIG. 3 is a block diagram of the modules of the block cipher system of FIG. 1;

FIG. 4 is a flow chart of a preferred mode of operation of the block cipher system of FIG. 1;

FIG. 5 is a cryptographic process flow diagram of a block cipher system constructed and operative in accordance with an alternative preferred embodiment of the present invention;

FIG. 6 is a cryptographic process flow diagram of a block cipher system constructed and operative in accordance with another alternative preferred embodiment of the present invention;

FIG. 7 is a block diagram of the modules of the block cipher system of FIG. 5 or 6;

FIG. 8 is an illustration of a hardened Feistel-like structure for use with a preferred embodiment of the present invention;

FIG. 9 is an illustration of a Combine Key RightPart function comprised in the hardened Feistel-like structure of FIG. 8;

FIG. 10 is an illustration of a preferred implementation of hardware for a RightPart Expansion Function comprised in the Combine Key RightPart function of FIG. 9;

FIG. 11 is an illustration of a preferred embodiment of a mini-function, the mini-function serving as a building block for a Mix and Condense function comprised in the Combine Key RightPart function of FIG. 9;

FIG. 12 is an illustration of a Combine RightPart Combine LeftPart function comprised in the hardened Feistel-like structure of FIG. 8;

FIG. 13 is an illustration of one preferred implementation of a linear layer in the Combine RightPart Combine LeftPart function of FIG. 12;

FIG. 14 is an illustration of one preferred implementation of an S-boxes layer in the Combine RightPart Combine LeftPart function of FIG. 12;

FIG. 15 is an illustration of one preferred implementation of a key expansion function comprised in the hardened Feistel-like structure of FIG. 8;

FIG. 16 is an illustration of one preferred implementation of round key generation utilizing the Mix and Condense function in the key expansion function of FIG. 15;

FIGS. 17-20 are simplified flowchart illustrations of preferred alternative methods of operation of the hardened Feistel-like structure of FIG. 8, in accordance with preferred embodiments thereof;

FIG. 21 is a simplified block diagram illustration of a system for robust cipher design for use with a preferred embodiment of the present invention;

FIG. 22 is a time line showing one preferred implementation of the relationship between key expansion and encryption rounds in a cipher designed according to the method of FIG. 21;

FIG. 23 is a simplified block diagram illustration depicting the use of MUX and DEMUX modules in a preferred implementation of the method of FIG. 21;

FIG. 24 is a simplified block diagram illustration of a preferred implementation of a round key generation function operative to generate round keys in a cipher designed according to the method of FIG. 21;

FIG. 25 is a simplified block diagram illustration of four rounds of a typical Feistel block cipher constructed and operative in accordance with the system of FIG. 21;

FIG. 26 is a simplified block diagram illustration of four rounds of a typical AES-like block cipher constructed and operative in accordance with the system of FIG. 21;

FIG. 27 is a simplified block diagram illustration of eight rounds of a typical Feistel block cipher constructed and operative in accordance with an alternative preferred embodiment of the system of FIG. 21;

FIG. 28 is a simplified block diagram illustration of eight rounds of a typical AES-like block cipher constructed and operative in accordance with an alternative preferred embodiment of the system of FIG. 21;

FIG. 29 is a simplified block diagram illustration of eight rounds of a typical Feistel block cipher constructed and operative in accordance with yet another alternative preferred embodiment of the system of FIG. 21;

FIG. 30 is a simplified block diagram illustration of eight rounds of a typical AES-like block cipher constructed and operative in accordance with yet another alternative preferred embodiment of the system of FIG. 21;

FIG. 31 is an illustration of a hardened Feistel-like structure for use with a preferred embodiment of the present invention;

FIG. 32 is an illustration of an alternative preferred embodiment of the hardened Feistel-like structure of FIG. 31;

FIG. 33 is a simplified block diagram of a preferred implementation of a MixKey function of the system of FIG. 31; and

FIG. 34 is a simplified block diagram of a CombParts function of the system of FIG. 31.

The following Appendices may be helpful in understanding certain preferred embodiments of the present invention:

Main Appendix is a description of a Feistel-like cipher system;

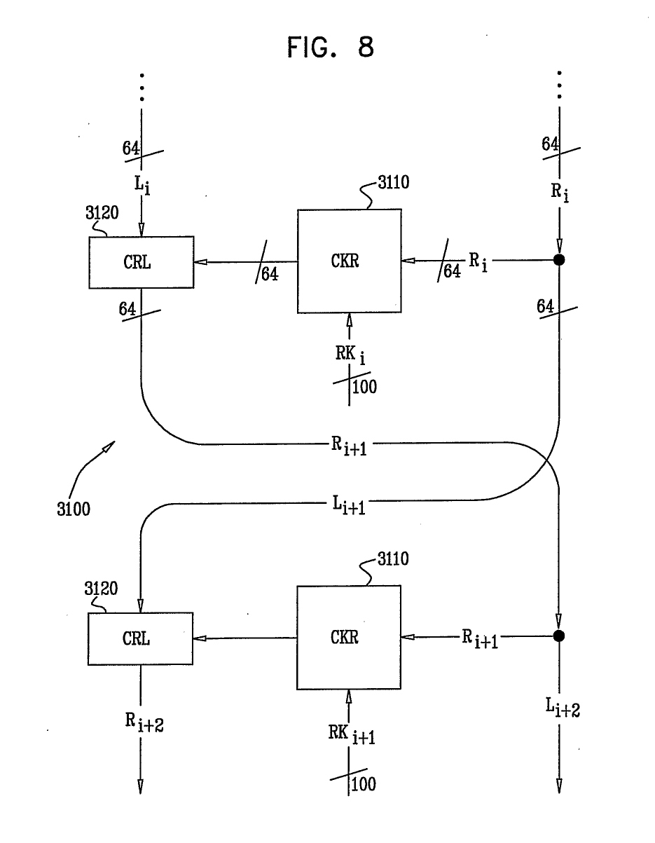

Appendix A is a description of a method for robust cipher design, comprising a preferred method of key expansion and set up and a preferred implementation of a round key encryption function, the method of Appendix A comprising a preferred implementation of the Feistel-like structure of FIG. 8;

Appendix B is a copy of Appendix A.5 of the Serpent Cipher specification, describing S-boxes S₀ through S₇ of the Serpent Cipher; and

Appendix C comprises a description of certain alternative preferred embodiments for use with a preferred embodiment of the present invention.

### DETAILED DESCRIPTION OF A PREFERRED EMBODIMENT

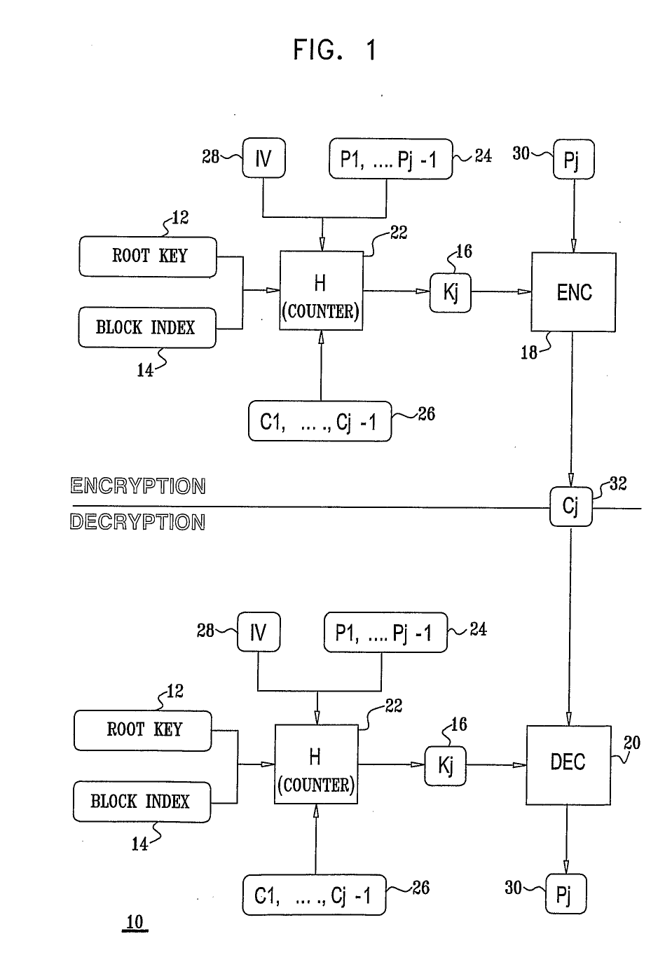

Reference is now made to FIG. 1, which is a cryptographic process flow diagram of a preferred general mode of operation of a block cipher system 10 constructed and operative in accordance with a preferred embodiment of the present invention. Block cipher system 10 includes a mode of operation of a block cipher for encryption and decryption of multiple blocks within a packet. The mode of operation forces the decryption process to run the key setup operation many times, preferably one-time for every block which is to be decrypted.

Since blocks in a single packet are preferably encrypted (and decrypted) using a different key, different terms are needed in order to distinguish between the different keys.

A root key 12 is the external key that is input into the cipher system. Each of the packets is preferably associated with one constant root key 12. In a broadcasting system, the same root key 12 is typically valid for a key period so that each root key 12 is used by more than one packet. In accordance with an alternative preferred embodiment of the present invention, more than one root key 12 may be used in the encryption/decryption process for each packet. In accordance with another alternative preferred embodiment of the present invention, all the packets are associated with the same root key.

An input key 16 (Kⱼ) is the actual key that is used for encrypting a plaintext block 30 (Pⱼ), or decrypting a ciphertext block 32 (Cⱼ) of a packet using an encryption function 18 or a decryption function 20, respectively.

The input key 16 (Kⱼ) is preferably determined using a function H (block 22) for plaintext block 30 and ciphertext block 32. The inputs of the function H (block 22) typically include one or more of the following: one or more of plaintext blocks 24 (P₁ to Pⱼ₋₁) of the packet that were processed (encrypted or decrypted) before the current block j; one or more of ciphertext blocks 26 (C₁ to Cⱼ₋₁) of the packet that were processed before the current block j; an Initialization Vector (IV) 28; the root key 12 and a block index 14. The function H (block 22) is operative to select or ignore all or part of the abovementioned inputs. For example, if the function H (block 22) ignores all the inputs except for the root key 12, the output of the function H (block 22) is the root key 12, so that the input key 16 is equal to the root key 12 and therefore the block cipher system 10 operates in the known Electronic Control Book (ECB) mode.

However, in accordance with a preferred embodiment of the present invention the input key 16 of the first block of a packet is preferably based on the root key 12 and the Initialization Vector 28. The input key 16 of subsequent blocks of the packet is typically based on: the root key 12 and one or more of the plaintext blocks 24 (P₁ to Pⱼ₋₁) of the packet that were processed (encrypted or decrypted) before the current block j; preferably one or more of the ciphertext blocks 26 (C₁ to Cⱼ₋₁) of the packet that were processed before the current block j; and preferably the block index 14.

The block index 14 allows the function H (block 22) to exhibit different behavior depending on the index of the block being processed. Alternatively, the function H (block 22) maintains a block counter internally by counting the number of blocks processed within a packet. It should be noted that the block counter is the same as the block index 14 if the blocks within a packet are processed in order.

The function H (block 22) typically combines the inputs into a single, input key 16 using simple operations such as bit-bit XOR or more complex operations such as a cryptographic hash function, for example, but not limited to, SHA-1.

It should be noted that the system may be implemented regardless of the order in which the blocks within a packet are processed. For example, the blocks may be processed in the same order in which they arrived over the communication media or in reverse order.

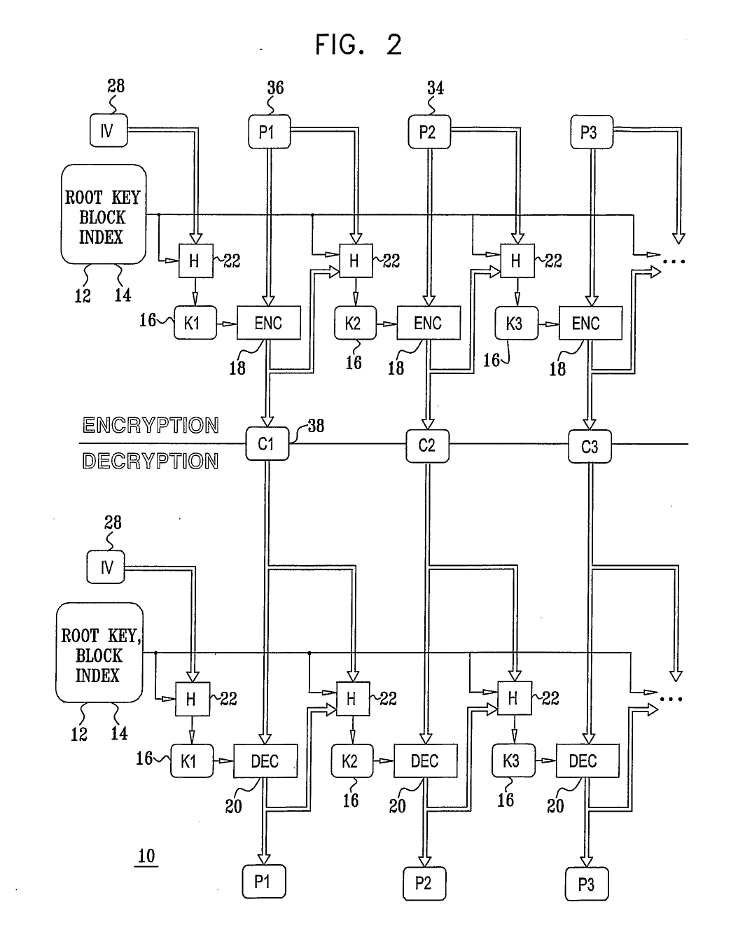

Reference is now made to FIG. 2, which is a cryptographic process flow diagram of a most preferred mode of operation of the block cipher system 10 of FIG. 1. In accordance with the most preferred mode of operation of the block cipher system 10, the input key 16 for encrypting/decrypting each block (except the first block in a packet, P₁), using the encryption function 18 and the decryption function 20, respectively, is determined by the function H (block 22) based on the root key 12, the block index 14, only the last processed (encrypted/decrypted) plaintext block and only the last processed (encrypted/decrypted) ciphertext block. For example, the input key 16 (K₂) for encrypting a plaintext block 34 (P₂) is based on the root key 12, the block index 14, only the last processed plaintext block 36 (P₁) and only the last processed ciphertext block 38 (C₁).

The input key 16 for the first block in the packet is based on the root key 12 and the Initialization Vector 28 and optionally the block index 14.

In the most preferred embodiment, parallelization is prevented with a minimal key setup cost, because the only intermediary results that need to be stored in memory while encrypting/decrypting a packet are the last plaintext block and preferably the last ciphertext block that was processed.

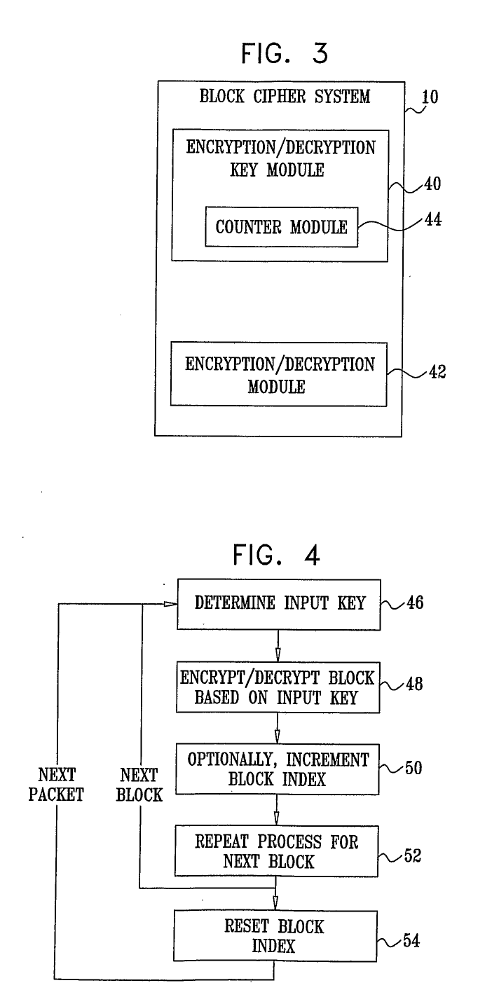

Reference is now made to FIGS. 3 and 4. FIG. 3 is a block diagram of the modules of the block cipher system 10 of FIG. 1. FIG. 4 is a flow chart of a preferred mode of operation of the block cipher system 10 of FIG. 1. Reference is also made to FIG. 1. The block cipher system 10 includes an encryption/decryption key module 40 and an encryption/decryption module 42.

The encryption/decryption key module 40 is operative to determine the input key 16 for the first block (P₁) based on the root key 12 and the initialization vector 28 and optionally the block index 14 (or the block counter) (block 46).

The encryption/decryption key module 40 is operative to determine the input keys 16 for the blocks other than the first block (P₁) based on: the root key 12; one or more of the plaintext blocks 24 previously encrypted/decrypted and most preferably only the last plaintext block 24 encrypted/decrypted; optionally the block index 14 or the block counter; and preferably one or more of the ciphertext blocks 26 previously encrypted/decrypted and most preferably only the last ciphertext block 26 encrypted/decrypted (block 46).

The block index 14 or the block counter also allows the encryption/decryption key module 40 to know which inputs to use in determining the input key 16, as the inputs for the first block differ from the inputs of the subsequent blocks, as described above.

The determination of the input key 16 by the encryption/decryption key module 40 is preferably performed using an exclusive-OR function and/or a cryptographic hash function, for example, but not limited to, SHA-1.

The encryption/decryption module 42 is operative to encrypt/decrypt each of the blocks based on the input key 16 of the block currently being encrypted/decrypted (block 48). In other words, the encryption/decryption module 42 is operative to encrypt/decrypt each of the blocks based on the input key 16 determined for each of the blocks, respectively.

The encryption/decryption key module 40 preferably includes a counter module 44 which is operative to maintain the block counter of the number of the blocks processed. The counter module 44 increments the block counter after each block has been processed (block 50).

The process of blocks 46-50 is preferably repeated for each of the data blocks in the packet (block 52).

The counter module 44 preferably resets the block counter after all the data blocks in the packet have been processed, ready for the next packet (block 54).

The process of blocks 46-52 is preferably repeated for all the packets in the data stream.

The components of the present invention are preferably implemented in hardware, using conventional techniques.

Although the system and method of the present invention is specifically designed to prevent software implementation in certain scenarios for example in a broadcast environment, in certain scenarios in may be possible to implement the method of the present invention using software techniques.

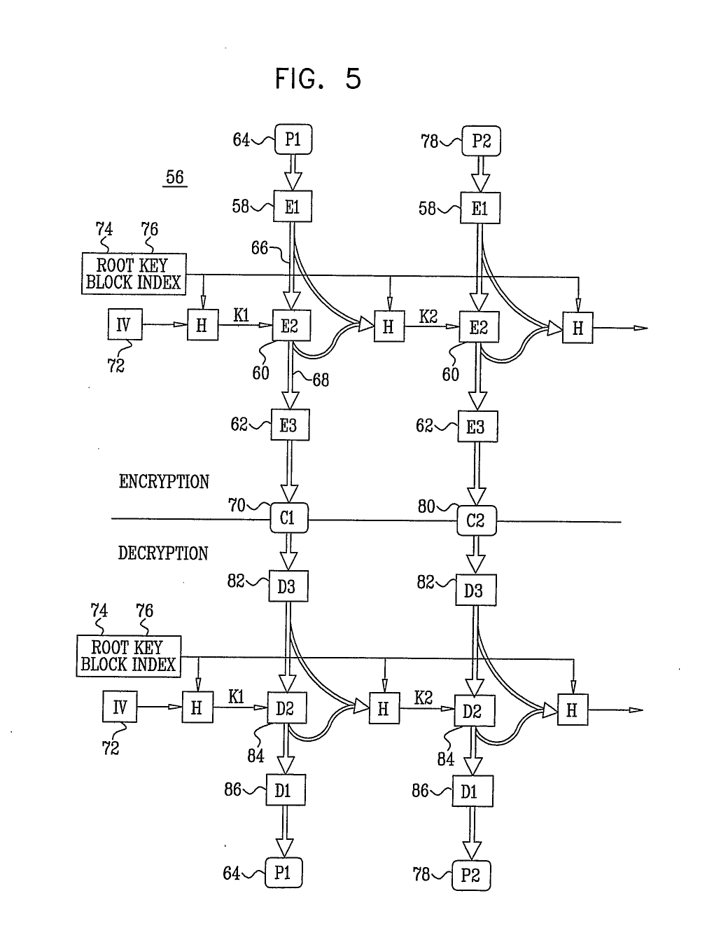

Reference is now made to FIG. 5, which is a cryptographic process flow diagram of a block cipher system 56 constructed and operative in accordance with an alternative preferred embodiment of the present invention. The block cipher system 56 typically includes an encryption block cipher arrangement having three block ciphers, a cipher 58, a cipher 60 and a cipher 62:

The ciphers 58, 60, 62 are preferably configured such that: a plaintext block 64 of a packet is encrypted by the cipher 58 producing an encrypted output 66; the encrypted output 66 is encrypted by the cipher 60 producing an encrypted output 68; the encrypted output 68 is encrypted by the cipher 62 producing a ciphertext block 70. Therefore, processing by the encryption block cipher arrangement from plaintext to ciphertext is performed such that between each of the block ciphers 58, 60, 62 there is an intermediate value which is a value between the plaintext and the ciphertext.

For the first plaintext block 64 in the packet, an encryption key, k₁, of the cipher 60 is typically determined by a function H with the following inputs: an initial value 72 and a root key 74 and optionally a block index 76.

The function H typically combines the inputs into a single input key using simple operations such as bit-bit XOR or more complex operations such as cryptographic hash functions, for example, but not limited to, SHA-1.

Subsequent blocks, for example, but not limited to, a second plaintext block 78, an encryption key, k₂, of the cipher 60 is generally determined by the function H with the following inputs: the root key 74; optionally the block index 76; and at least one intermediate value between the plaintext and ciphertext of a prior block, for example: the encrypted output of the cipher 58 for a prior block, preferably of the last prior processed block, for example, associated with the plaintext block 64; and preferably the encrypted output of the cipher 60 for a prior block, preferably of the last prior processed block, for example, associated with the plaintext block 64.

The output of the cipher 60 for the plaintext block 78 is encrypted by the cipher 62 producing a ciphertext block 80.

The ciphers 58, 60, 62 may be the same cipher (for example, but not limited to, triple-DES) or different ciphers selected from any suitable cipher for example, but not limited to, AES, DES, Triple-DES, IDEA, CAST, Blowfish, Skipjack and the Feistel-like Cipher described with reference to the Main Appendix and Appendices A, B and C.

Decryption of the ciphertext blocks 70, 80 is typically performed using three appropriate decryption block ciphers, a cipher 82, a cipher 84 and a cipher 86 corresponding to ciphers 62, 60, 58, respectively.

The ciphertext block 70 is preferably decrypted by the cipher 82. The output of the cipher 82 is typically decrypted by the cipher 84. The output of the cipher 84 is typically decrypted by the cipher 86 producing the plaintext block 64.

For the ciphertext block 70, the decryption key, k₁, of the cipher 84 is preferably determined by the function H with the following inputs: the initial value 72 and the root key 74 and optionally the block index 76.

Subsequent blocks, for example, but not limited to, the second ciphertext block 80, the decryption key, k₂, of the cipher 84 is preferably determined by the function H with the following inputs: the root key 74; optionally the block index 76; and at least one intermediate value between the ciphertext and plaintext of a prior block, for example: the decrypted output of the cipher 82 for a prior block, preferably of the last prior processed block, for example, associated with the ciphertext block 70; and preferably the decrypted output of the cipher 84 for a prior block, preferably of the last prior processed block, for example, associated with the ciphertext block 70.

The output of the cipher 60 for the ciphertext block 80 is typically decrypted by the cipher 86 producing the plaintext block 78.

As the plaintext and ciphertext may be controlled by an attacker the block cipher system 56 helps prevent related key attacks on the block cipher system 56 by using the intermediate values between the plaintext and the ciphertext as input for the function H for a future block.

It will be appreciated by those ordinarily skilled in the art that the block cipher arrangement can include more than three block ciphers as long as an intermediate value of a prior block is used as an input for determining the key of a current block for one of the block ciphers.

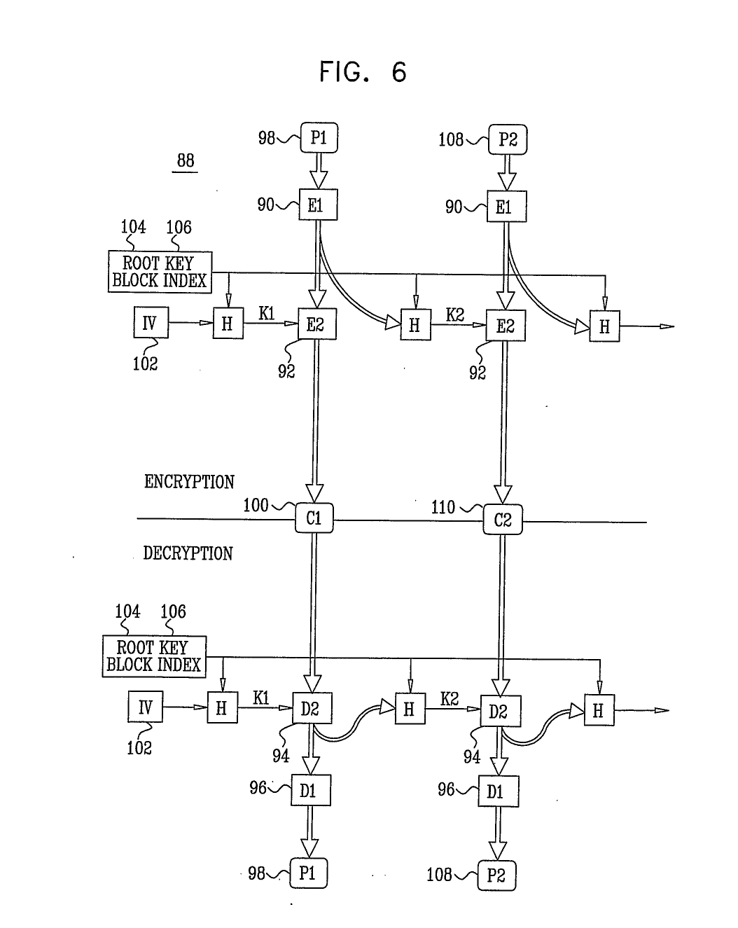

Reference is now made to FIG. 6, which is a cryptographic process flow diagram of a block cipher system 88 constructed and operative in accordance with another alternative preferred embodiment of the present invention. The block cipher system 88 is substantially the same as the block cipher system 56, except that the block cipher system 88 has an encryption cipher arrangement preferably including two ciphers, a cipher 90 and a cipher 92. The block cipher system 88 has a decryption cipher arrangement preferably including two ciphers, a cipher 94 and a cipher 96.

For a first plaintext block 98 or ciphertext block 100 of a packet, the encryption/decryption key, k₁, of the ciphers 92, 94 is preferably determined by the function H with the following inputs: an initial value 102 and a root key 104 and optionally a block index 106.

For subsequent blocks, for example, but not limited to, a second plaintext block 108 or a second ciphertext block 110, the encryption/decryption key, k₂, of the ciphers 92, 94 is preferably determined by the function H with the following inputs: the root key 104; optionally the block index 106; and an intermediate value between the ciphertext and plaintext of a prior block, for example: the output of the cipher 90 or the cipher 94 as appropriate for a prior block, preferably the last prior processed block.

It will be appreciated that the present invention, in preferred embodiments thereof, is most suitably implemented using ciphers which are computationally intensive with respect to key setup, for example, but not limited to the blowfish cipher described in the following paper: “New Variable-Length Key, 64-Bit Block Cipher (Blowfish)” by B. Schneier published at a conference entitled Fast Software Encryption, Cambridge Security Workshop Proceedings (December 1993), Springer-Verlag, 1994, pp. 191-204.

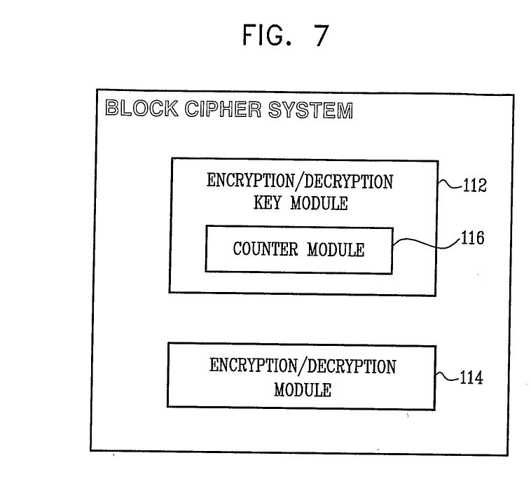

Reference is now made to FIG. 7, which is a block diagram of the modules of the block cipher system 56 of FIG. 5 or the block cipher system 88 of FIG. 6. The functionality of the block cipher system 56 of FIG. 5 and the block cipher system 88 of FIG. 6 are preferably implemented with an encryption/decryption key module 112 and an encryption/decryption module 114.

The encryption/decryption module 114 preferably includes a plurality of block ciphers (for example, three ciphers of FIG. 5 or two ciphers of FIG. 6). It will be appreciated by those ordinarily skilled in the art that the encryption/decryption module 114 can include two, three or more ciphers for encryption/decryption.

The ciphers of the encryption/decryption module 114 are typically operative to jointly encrypt/decrypt between plaintext and ciphertext such that, for each of a plurality of blocks, between a first pair of the block ciphers (for example, between ciphers 58, 60 of FIG. 5 or ciphers 90, 92 of FIG. 6) there is a first intermediate value which is a value between the plaintext and the ciphertext. The term “encrypt/decrypt between the plaintext and the ciphertext” as used in the specification and claims is defined as encrypting from plaintext to ciphertext and/or decrypting from ciphertext to plaintext. The term “encryption/decryption” as used in the specification and claims, in all grammatical forms thereof, is defined as encryption and/or decryption.

At least one of the ciphers (for example, cipher 60 of FIG. 5 or cipher 92 of FIG. 6) preferably performs encryption/decryption based on an input key.

The encryption/decryption key module 112 is generally operative to determine the input key for each block based on a function having a plurality of inputs typically including: the root key and an initialization vector, for a first block; and the first intermediate value of a prior block (preferably of the last prior-processed block) and the root key, for the blocks other than the first block.

The encryption/decryption key module 112 preferably includes a counter module 116 to maintain a block counter of the number of the blocks processed.

The input key is optionally also based on a block-index/block counter of the block being processed.

When the encryption/decryption module 114 typically includes three or more ciphers for encryption/decryption, the encryption/decryption between the plaintext and the ciphertext is preferably performed jointly by the three or more block ciphers. Between a second pair of the block ciphers (which may include one of the ciphers of the first pair of ciphers), for each of the blocks, there is generally a second intermediate value which is a value between the plaintext and the ciphertext. The encryption/decryption module 114 is preferably operative to determine the input key, for the blocks other than the first block, such that an input of the function for determining the input key also includes the second intermediate value of a prior block (preferably of the last prior-processed block). It will be appreciated by those ordinarily skilled in the art that processing packets of streamed content is used by way of example only, and that any suitable embodiment of the present invention can be used to encrypt/decrypt suitable blocks of data for example, but not limited to, encrypting/decrypting sectors on a disk.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination. It will also be appreciated by persons skilled in the art that the present invention is not limited by what has been particularly shown and described hereinabove. Rather the scope of the invention is defined only by the claims which follow.

### MAIN APPENDIX

### Feistel Like Cipher

### BACKGROUND

Many encryption methods are known in the art. Of the known methods, many methods are block methods in which a block of plain text is iteratively altered according to a predefined rule; each such iteration is also known as a “round”.

Many block encryption methods can be viewed as specific cases of Feistel networks, also termed herein “Feistel cipher methods”, or “Feistel-like cipher methods”; a single round of a Feistel cipher method is termed herein a “Feistel cipher round”.

Feistel ciphers are described in the Handbook of Applied Cryptography (A. Menezes, P. van Oorschot, and S. Vanstone, CRC Press, 1996. The Handbook of Applied Cryptography (HAC) is available on the Internet at www.cacr.math.uwaterloo.ca/hac). The discussion of Feistel ciphers in HAC, on pages 250-259, is incorporated herein by reference.

A Feistel cipher is an iterated block cipher mapping a plaintext (comprising two parts, L₀ and R₀), for t-bit blocks L₀ and R₀, to a ciphertext (Rᵣ and Lᵣ), through an r-round process where r≧1. For 1≦i≦r, round I maps (Lᵢ₋₁, Rᵢ₋₁) using key Kᵢ to (Lᵢ, Rᵢ) as follows: Lᵢ=Rᵢ₋₁, Rᵢ=Lᵢ₋₁⊕f(Rᵢ₋₁, Kᵢ), where each subkey Kᵢ is derived from the cipher key K (HAC, page 251).

Those skilled in the art will appreciate that although the definition above is for blocks L₀ and R₀ of equal sizes, equality of the sizes is not mandatory.

Decryption of a Feistel cipher is often achieved using the same r-round process but with subkeys used in reverse order, Kᵣ through K₁.

Types of block ciphers which are cases of Feistel networks include the following well-known methods: DES, Lucifer, FEAL, Khufu, Khafre, LOKI, GOST, CAST, and Blowfish.

Feistel ciphers are also discussed in Applied Cryptography, Second Edition (B. Schneier, John Wiley and Sons, Inc., 1996) on pages 347-351. The discussion of Feistel ciphers in Applied Cryptography, Second Edition is hereby incorporated herein by reference.

DES is specified in FIPS 46-3, available on the Internet at: csrc.nist.gov/publications/fips/fips46-3/fips46-3.pdf. FIPS 46-3 is hereby incorporated herein by reference.

FOX: A New Family of Block Ciphers, (Pascal Junod and Serge Vaudenay, Selected Areas in Cryptography 2004: Waterloo, Canada, Aug. 9-10, 2004. Revised papers, Lecture Notes in Computer Science. Springer-Verlag.) describes the design of a new family of block ciphers based on a Lai-Massey scheme, named FOX. The main features of the design, besides a very high security level, are a large implementation flexibility on various platforms as well as high performances. In addition, a new design of strong and efficient key-schedule algorithms is proposed. Evidence is provided that FOX is immune to linear and differential cryptanalysis.

How to Construct Pseudorandom Permutations From Pseudorandom Functions (M. Luby and C. Rackoff., SIAM Journal on Computing, 17:2, pp. 373-386, April 1988), describes a method to efficiently construct a pseudorandom invertible permutation generator from a pseudorandom function generator. A practical result described in Luby-Rackoff is that any pseudorandom bit generator can be used to construct a block private key cryptosystem which is secure against chosen plaintext attacks, which is one of the strongest known attacks against a cryptosystem.

The Serpent Cipher, specified at: www.ftp.cl.cam.ac.uk/ftp/users/rja14/serpent.pdf, was an Advanced Encryption Standard (AES) candidate. The design of the serpent cipher design is highly conservative, yet still allows a very efficient implementation. The serpent cipher uses S-boxes similar to those of DES in a new structure that simultaneously allows a more rapid avalanche, and a more efficient bitslice implementation.

The disclosures of all references mentioned above and throughout the present specification, as well as the disclosures of all references mentioned in those references, are hereby incorporated herein by reference.

### SUMMARY

The method described in this Appendix seeks to provide an improved encryption method, and in particular an improved encryption method related to Feistel encryption methods. A Feistel-like cipher, described herein, is preferably designed to be easily implemented in hardware and difficult to implement in software.

### BRIEF DESCRIPTION OF THE DRAWINGS AND APPENDICES

The present Appendix will be understood and appreciated more fully from the following detailed description, taken in conjunction with the drawings in which:

FIG. 8 is an illustration of a hardened Feistel-like structure for use with a preferred embodiment of the present invention;

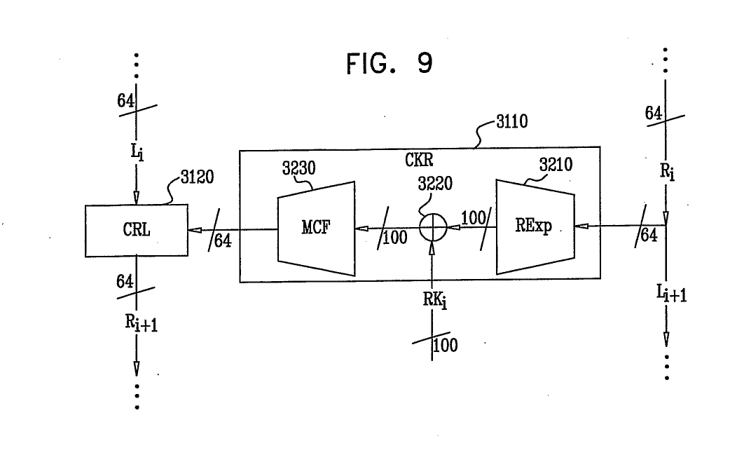

FIG. 9 is an illustration of a Combine Key RightPart function comprised in the hardened Feistel-like structure of FIG. 8;

FIG. 10 is an illustration of a preferred implementation of hardware for a RightPart Expansion Function comprised in the Combine Key RightPart function of FIG. 9;

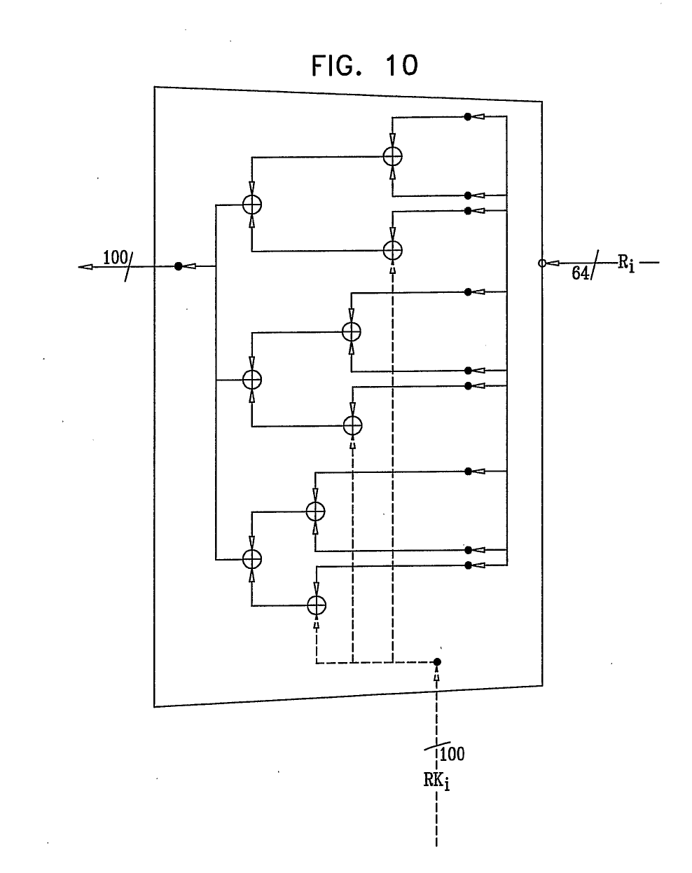

FIG. 11 is an illustration of a preferred embodiment of a mini-function, the mini-function serving as a building block for a Mix and Condense function comprised in the Combine Key RightPart function of FIG. 9;

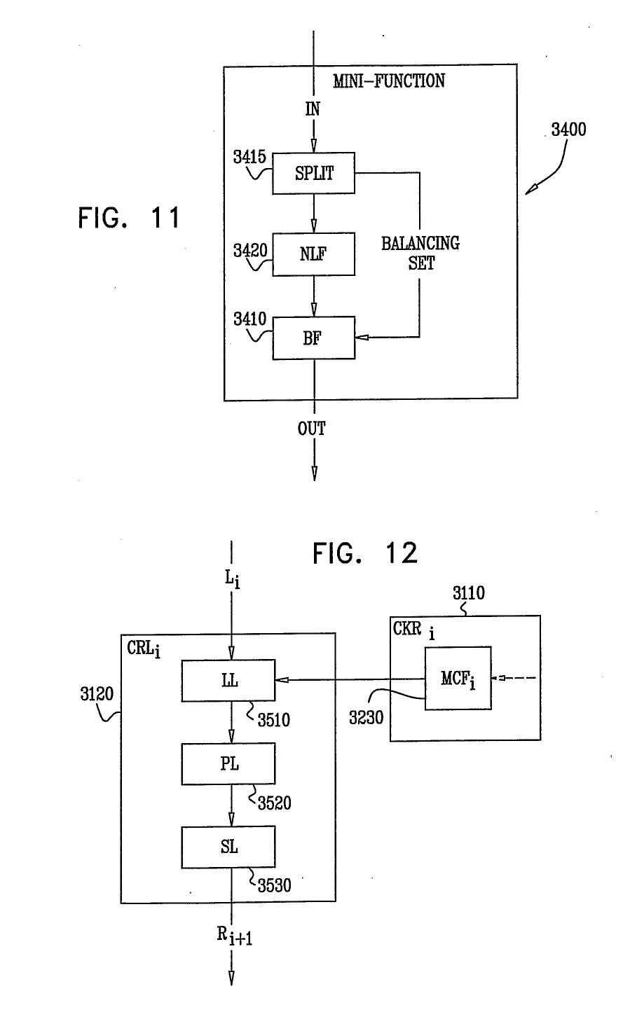

FIG. 12 is an illustration of a Combine RightPart Combine LeftPart function comprised in the hardened Feistel-like structure of FIG. 8;

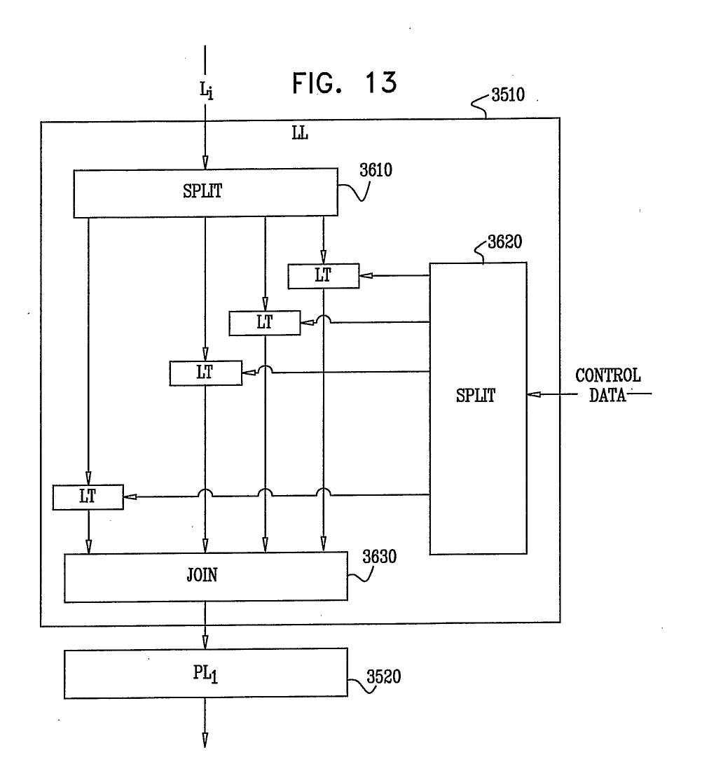

FIG. 13 is an illustration of one preferred implementation of a linear layer in the Combine RightPart Combine LeftPart function of FIG. 12;

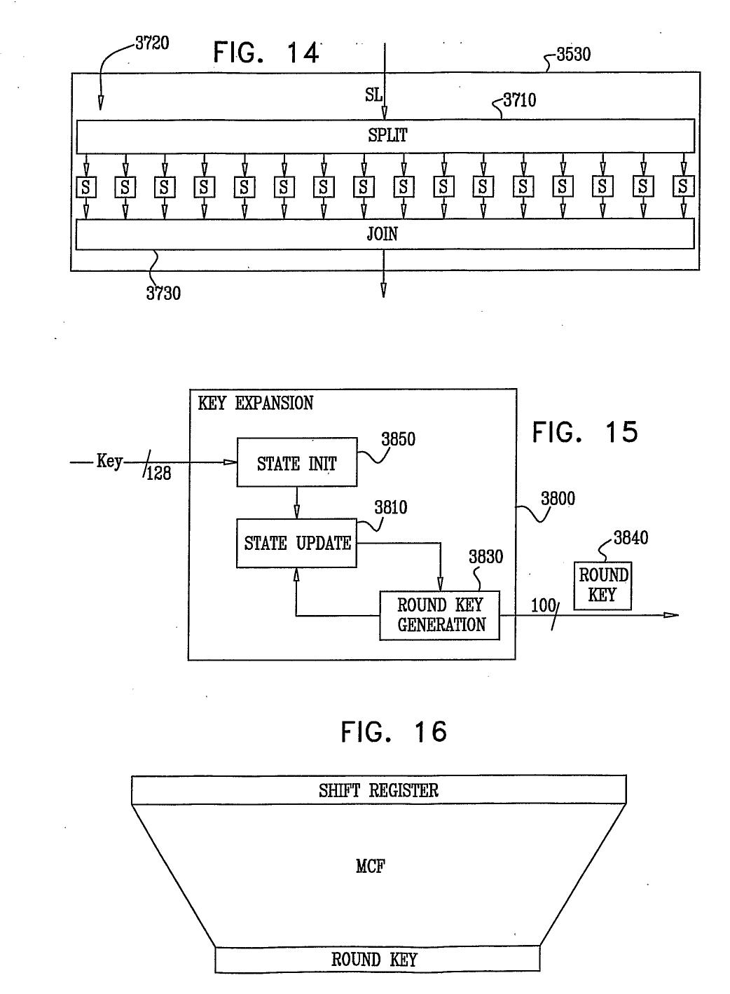

FIG. 14 is an illustration of one preferred implementation of an S-boxes layer in the Combine RightPart Combine LeftPart function of FIG. 12;

FIG. 15 is an illustration of one preferred implementation of a key expansion function comprised in the hardened Feistel-like structure of FIG. 8;

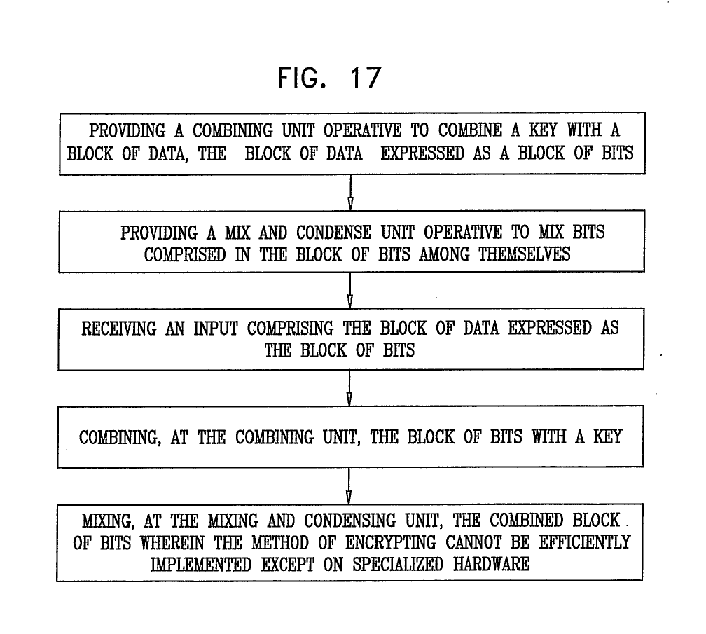

FIG. 16 is an illustration of one preferred implementation of round key generation utilizing the Mix and Condense function in the key expansion function of FIG. 15;

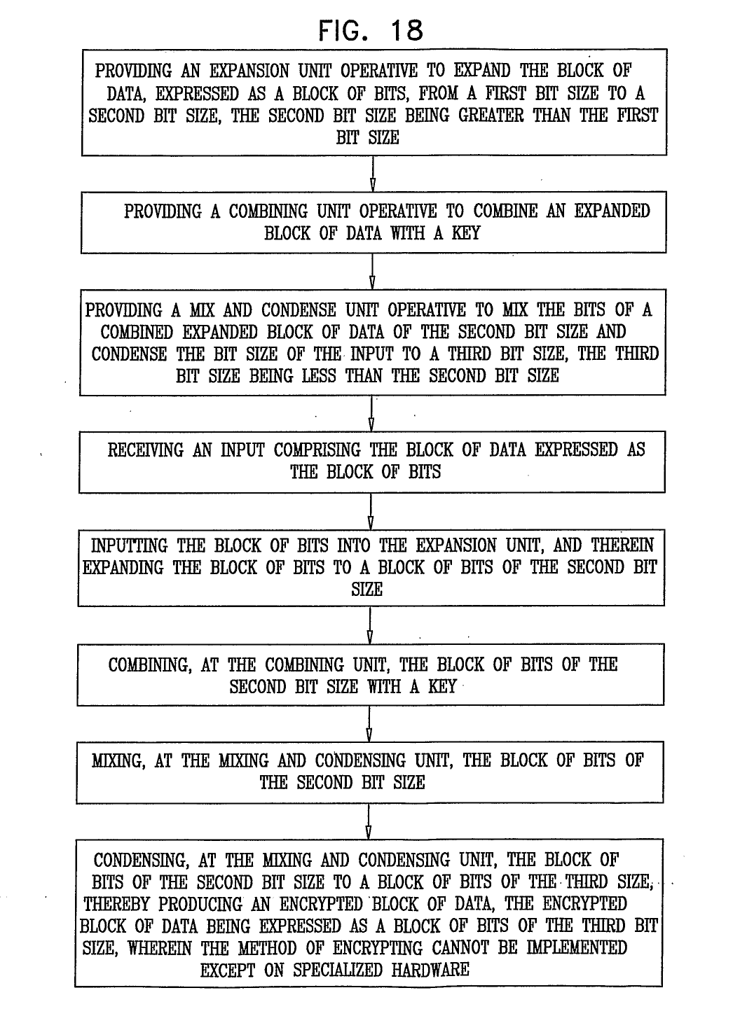

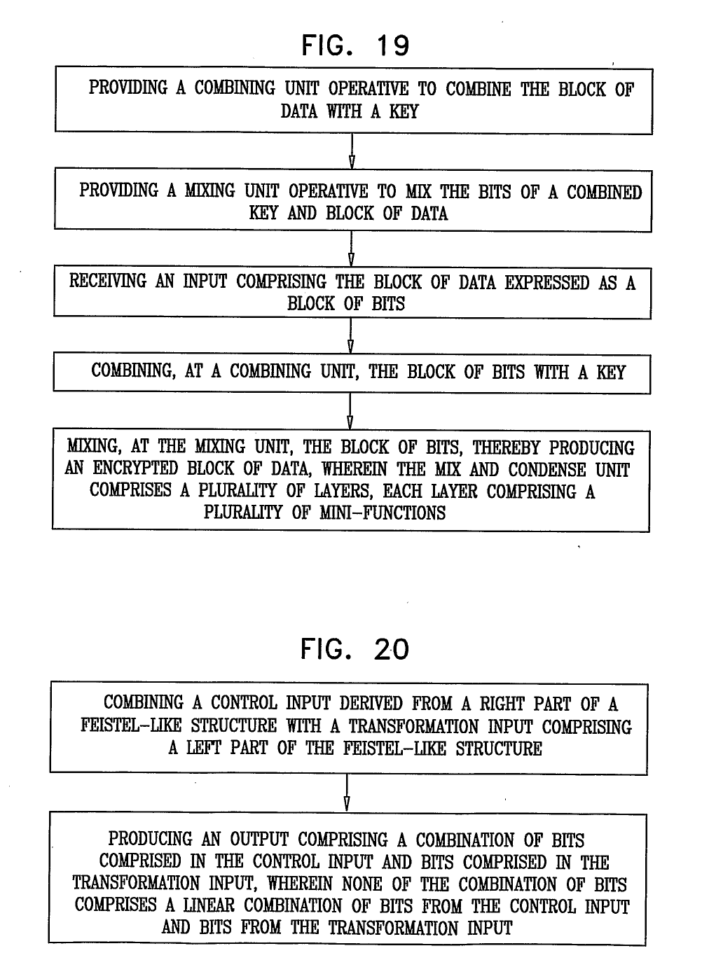

FIGS. 17-20 are simplified flowchart illustrations of preferred alternative methods of operation of the hardened Feistel-like structure of FIG. 8, in accordance with preferred embodiments thereof;

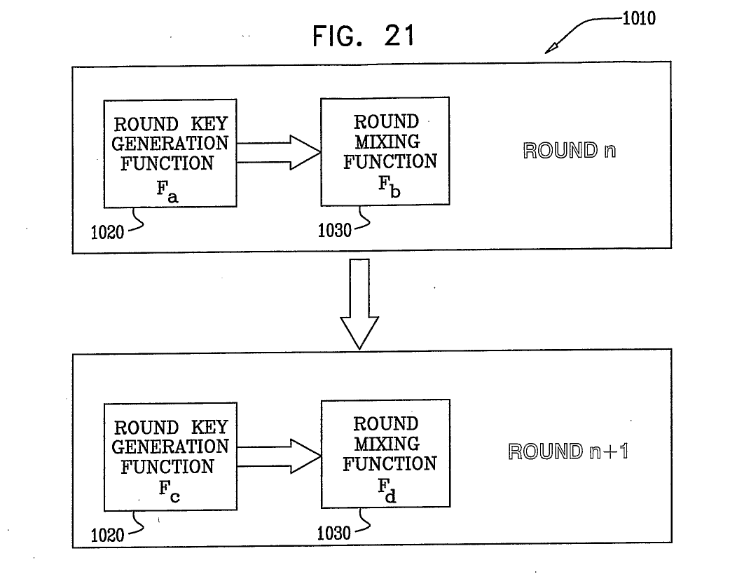

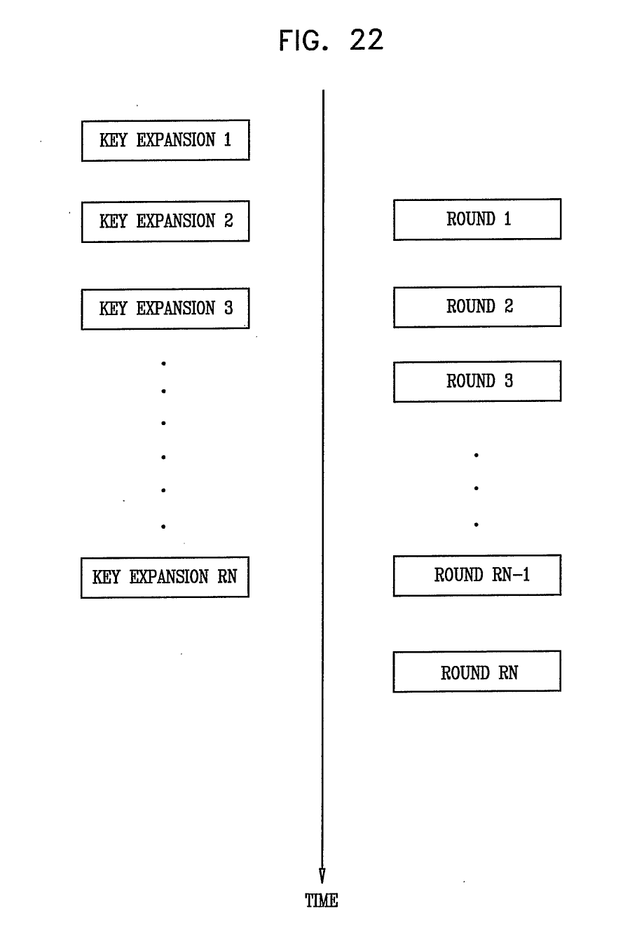

FIG. 21 is a simplified block diagram illustration of a system for robust cipher design for use with a preferred embodiment of the present invention;

FIG. 22 is a time line showing one preferred implementation of the relationship between key expansion and encryption rounds in a cipher designed according to the method of FIG. 21;

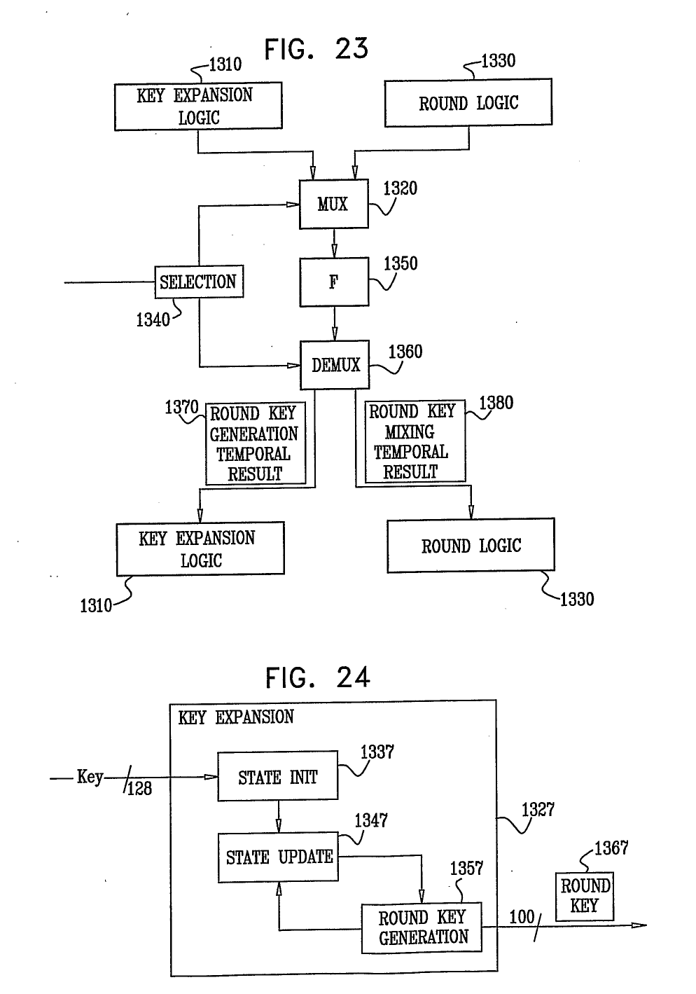

FIG. 23 is a simplified block diagram illustration depicting the use of MUX and DEMUX modules in a preferred implementation of the method of FIG. 21;

FIG. 24 is a simplified block diagram illustration of a preferred implementation of a round key generation function operative to generate round keys in a cipher designed according to the method of FIG. 21;

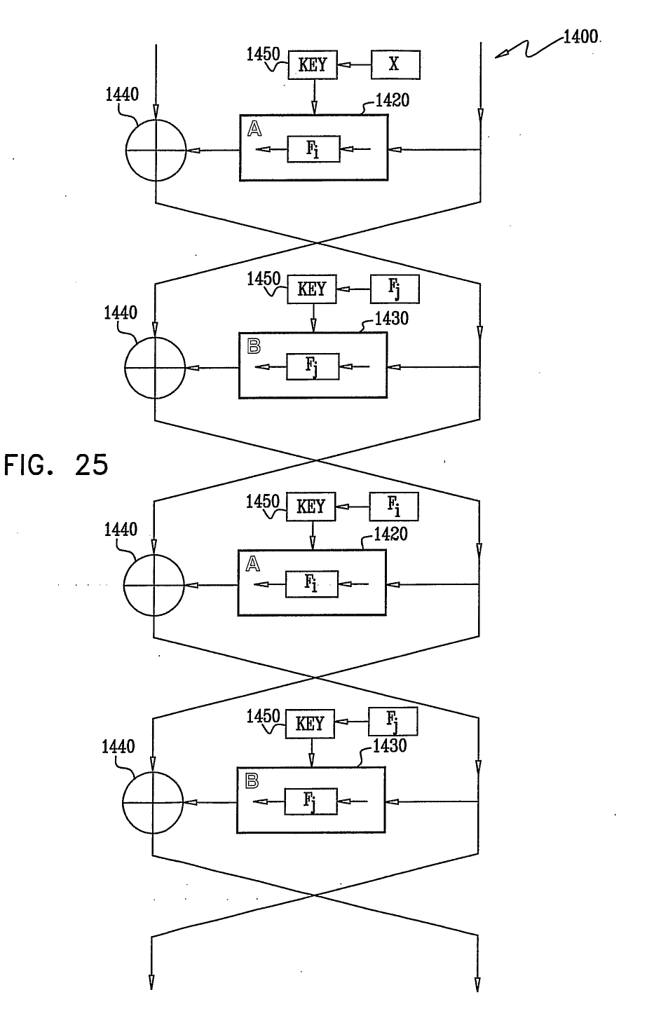

FIG. 25 is a simplified block diagram illustration of four rounds of a typical Feistel block cipher constructed and operative in accordance with the system of FIG. 21;

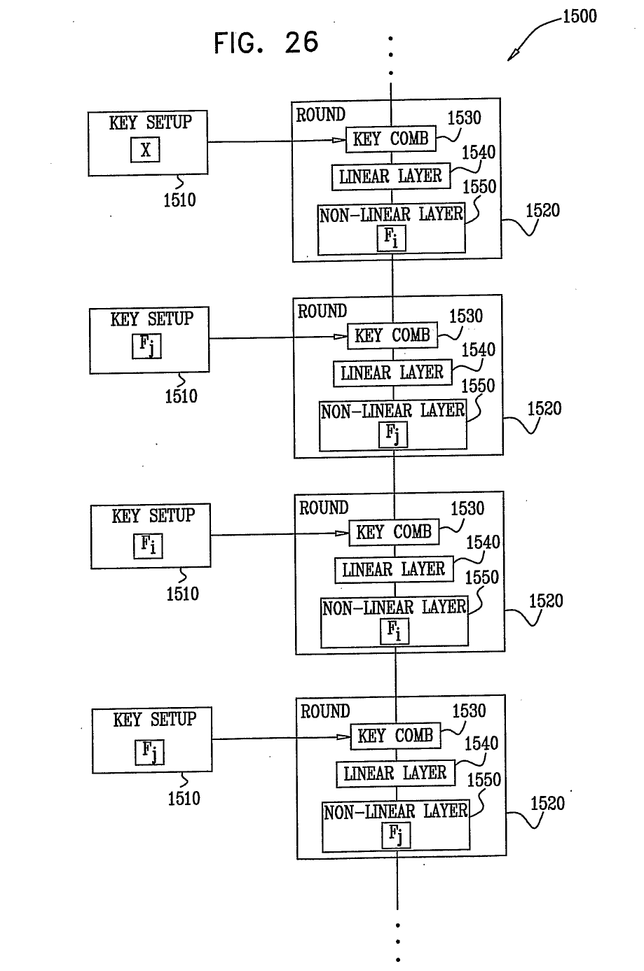

FIG. 26 is a simplified block diagram illustration of four rounds of a typical AES-like block cipher constructed and operative in accordance with the system of FIG. 21;

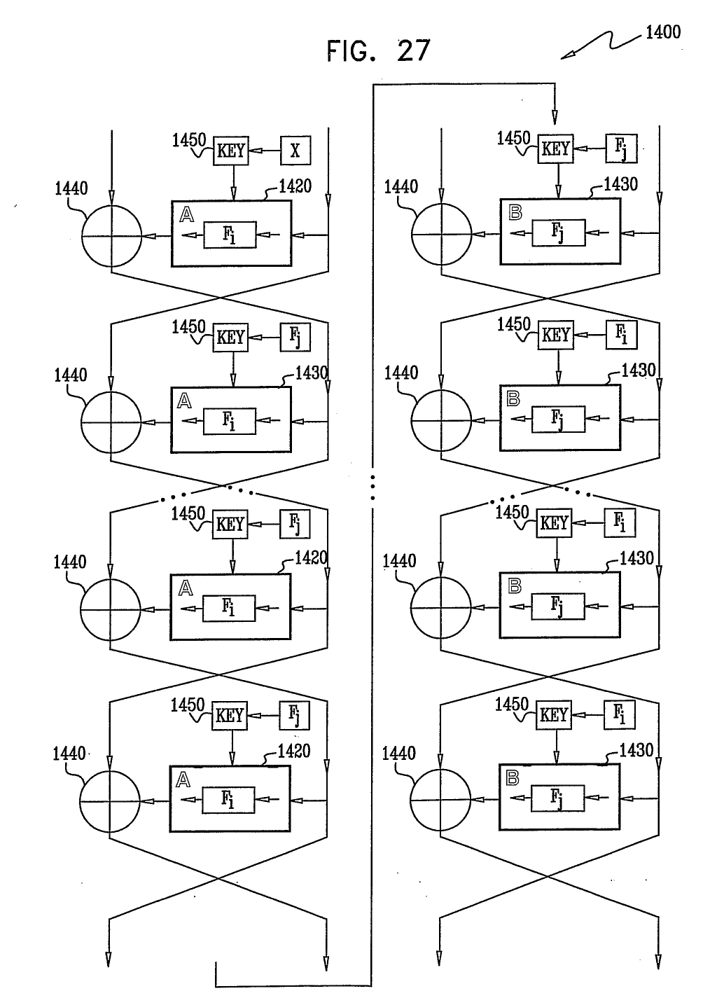

FIG. 27 is a simplified block diagram illustration of eight rounds of a typical Feistel block cipher constructed and operative in accordance with an alternative preferred embodiment of the system of FIG. 21;

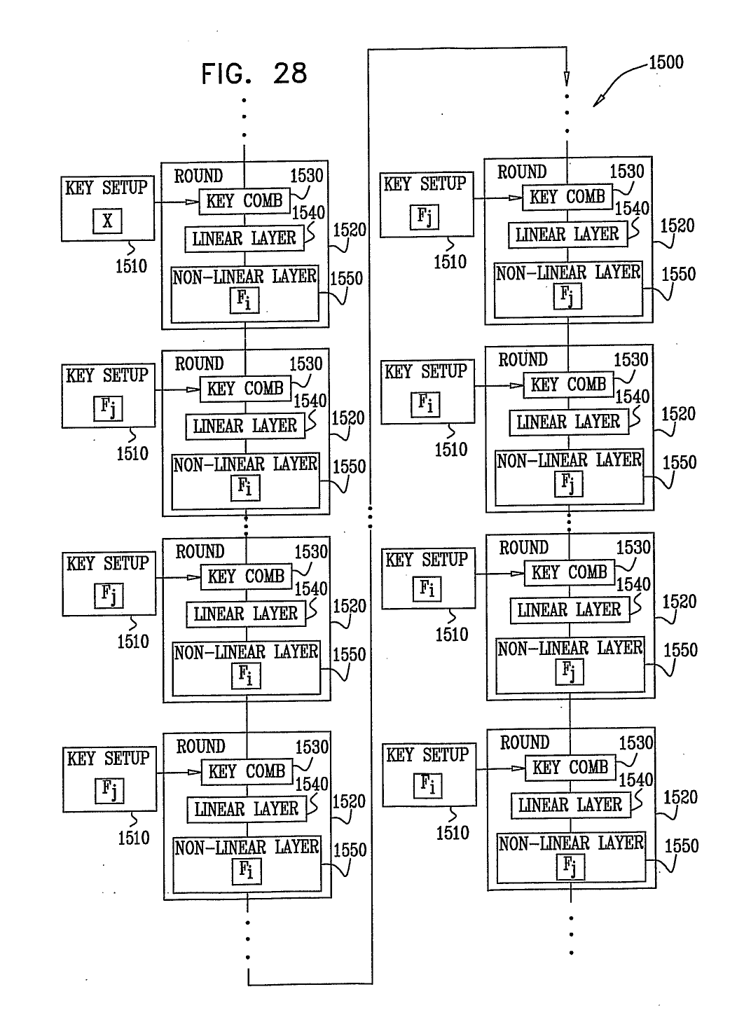

FIG. 28 is a simplified block diagram illustration of eight rounds of a typical AES-like block cipher constructed and operative in accordance with an alternative preferred embodiment of the system of FIG. 21;

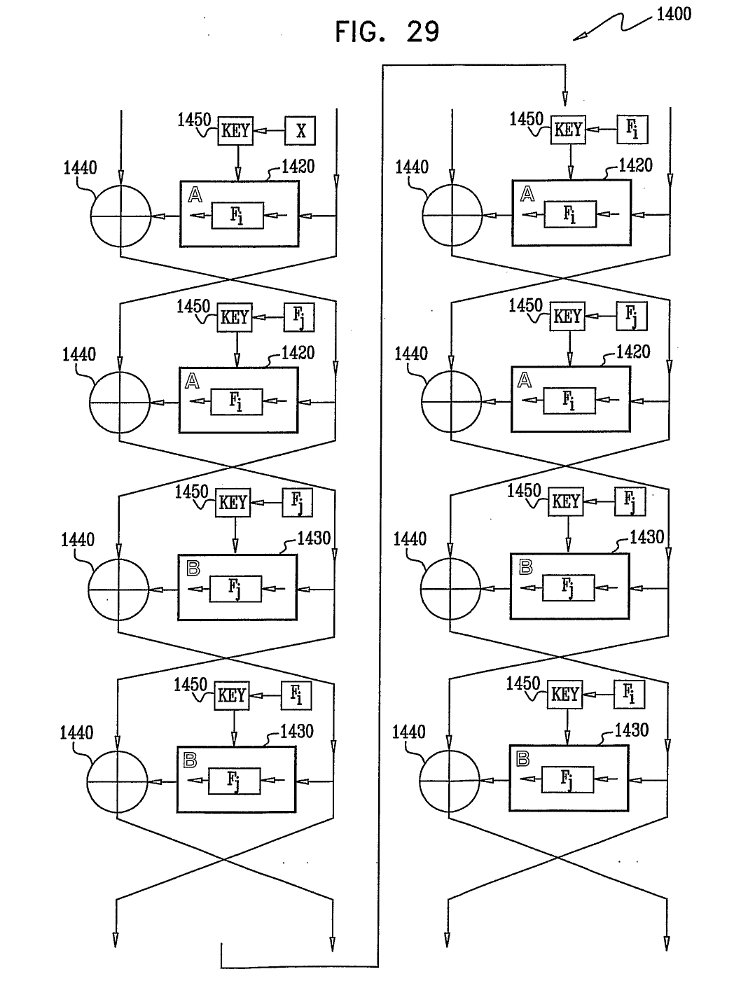

FIG. 29 is a simplified block diagram illustration of eight rounds of a typical Feistel block cipher constructed and operative in accordance with yet another alternative preferred embodiment of the system of FIG. 21;

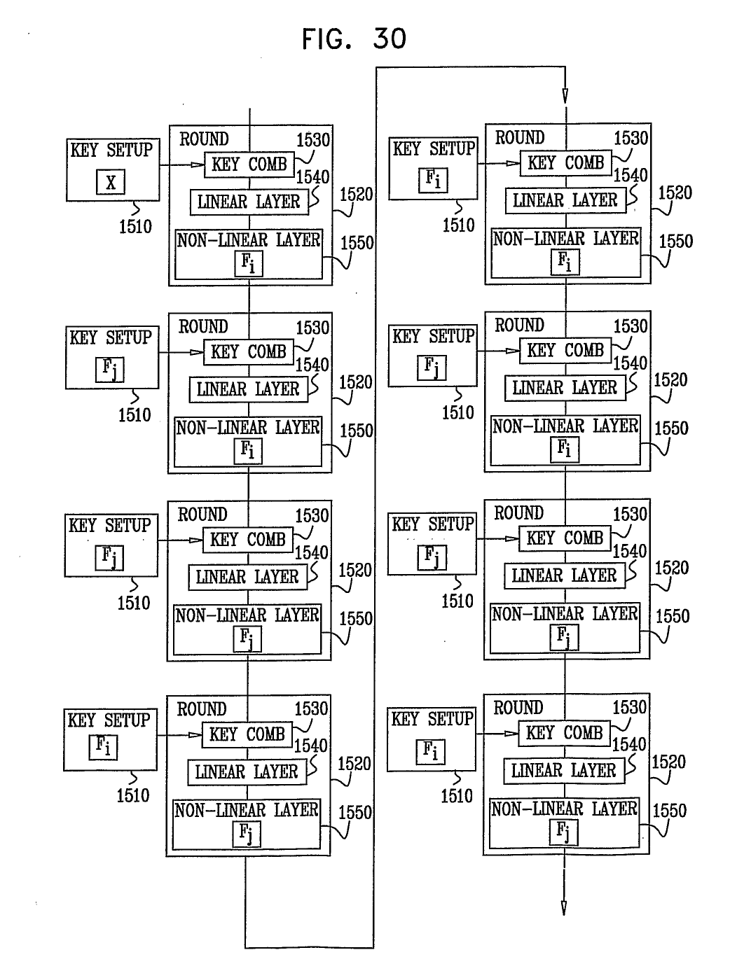

FIG. 30 is a simplified block diagram illustration of eight rounds of a typical AES-like block cipher constructed and operative in accordance with yet another alternative preferred embodiment of the system of FIG. 21;

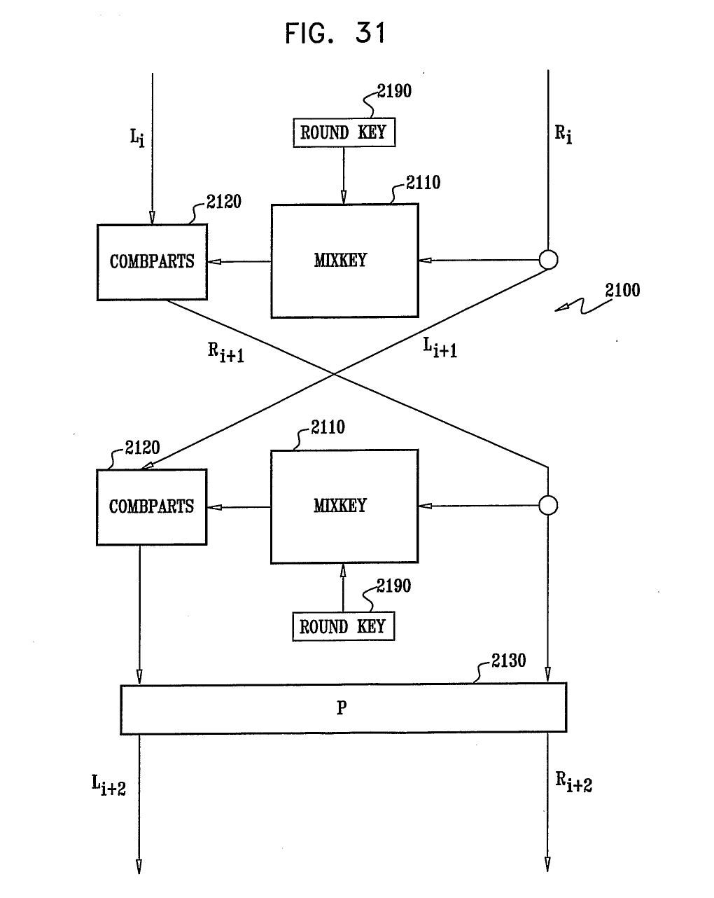

FIG. 31 is an illustration of a hardened Feistel-like structure for use with a preferred embodiment of the present invention;

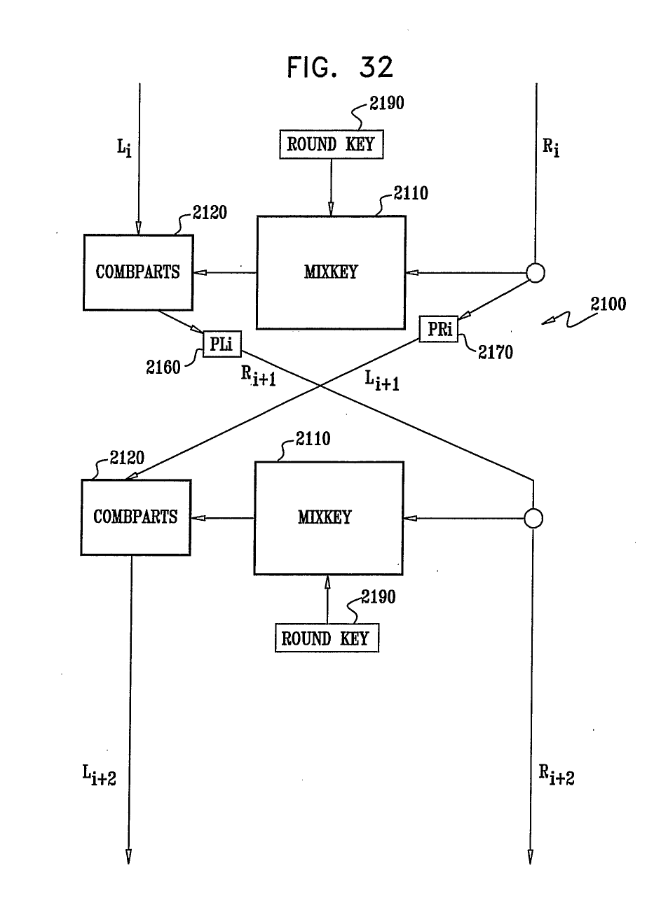

FIG. 32 is an illustration of an alternative preferred embodiment of the hardened Feistel-like structure of FIG. 31;

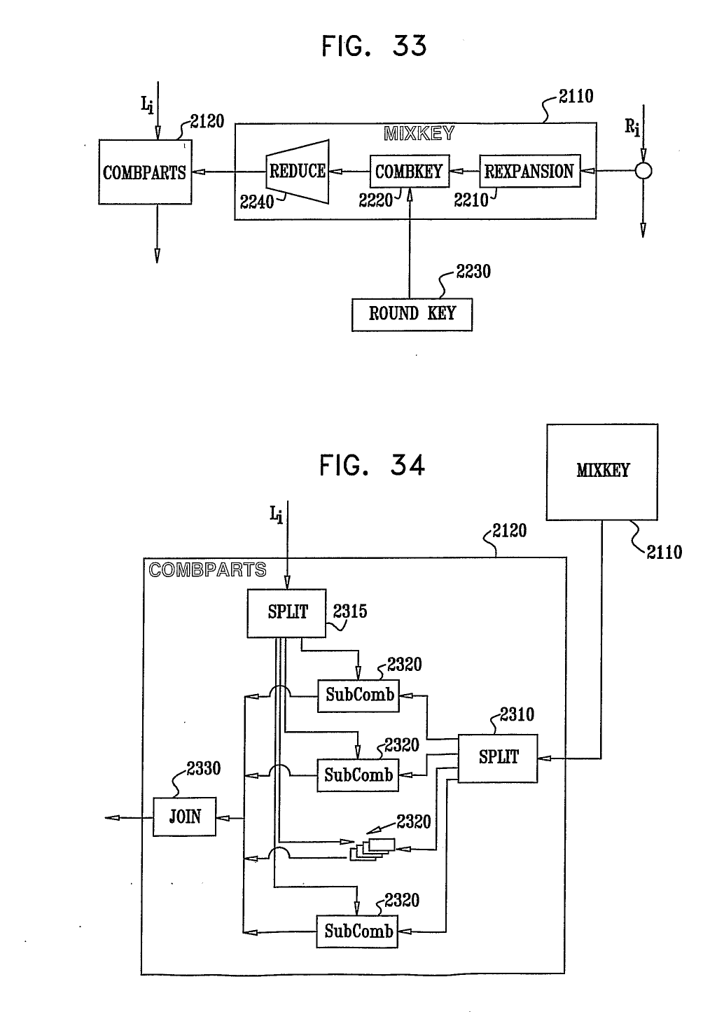

FIG. 33 is a simplified block diagram of a preferred implementation of a MixKey function of the system of FIG. 31; and

FIG. 34 is a simplified block diagram of a CombParts function of the system of FIG. 31.

The following Appendices may be helpful in understanding certain preferred embodiments of the present Appendix:

Appendix A is a description of a method for robust cipher design, comprising a preferred method of key expansion and set up and a preferred implementation of a round key encryption function, the method of Appendix A comprising a preferred implementation of the Feistel-like structure of FIG. 8;

Appendix B is a copy of Appendix A.5 of the Serpent Cipher specification, describing S-boxes S₀ through S₇ of the Serpent Cipher; and

Appendix C comprises a description of certain alternative preferred embodiments for use with the present invention.

### DETAILED DESCRIPTION OF A PREFERRED EMBODIMENT

Reference is now made to FIG. 8, which is an illustration of a hardened Feistel-like structure 3100 for use with a preferred embodiment of the present invention. It is appreciated that FIG. 8 provides an illustration of data structures and methods for implementing an encryption network, the illustration being drawn in a format which is well known in the art. FIG. 8 depicts two rounds of the hardened Feistel-like structure 3100, it being appreciated that a plurality of rounds comprising more than two rounds is preferred, similarly to the plurality of rounds known in the prior art in the case of Feistel-like networks.

The Feistel-like structure 3100 of FIG. 8 comprises a Combine Key RightPart (CKR) function 3110, a preferred implementation of which is described below with reference to FIG. 9, and a Combine RightPart Combine LeftPart (CRL) function 3120, a preferred implementation of which is described below described below with reference to FIG. 12. A preferred implementation of a key expansion function (not depicted in FIG. 8), operative to provide a round key (RKᵢ, RKᵢ₊₁) for each round of the Feistel-like structure 3100 is described below with reference to FIG. 15.

In each round of the hardened Feistel-like structure 3100, two halves of a plaintext, left and right, depicted as L and R, are operated on by the CKR function 3110 and the CRL function 3120. It is appreciated that in each round, L and R preferably have an identical size of 64 bits. It is nevertheless appreciated that L and R may be any equal size, and 64 bits is used herein as an example. It is further appreciated that the size of the round key, RKᵢ, is described herein as 100 bits by way of example, only. RKᵢ may be any appropriate size.

It is appreciated that the plurality of rounds may preferably be preceded by preprocessing of L and R. For example, L and R may preferably be permuted according to a pre-defined permutation in the same manner the DES block cipher permutes the input before the first round (refer to FIPS 46-3). It is further appreciated that after the plurality of rounds are completed, an encrypted output of the hardened Feistel-like structure 3100 may be post-processed. For example, output may preferably be further permuted according to a pre-defined permutation in the same manner the DES block cipher permutes the state after the 16^{th} round (refer to FIPS 46-3).

For any given n rounds of the hardened Feistel-like structure 3100, a particular round (first round, last round, or any other round) may preferably differ from the other n−1 rounds.

The Feistel-like structure 3100 preferably uses a 128-bit key to encrypt and decrypt 128-bit blocks. The number of rounds (RN) is preferably RN between 40 and 50, inclusive.

It is appreciated that the Feistel-like structure 3100 is preferably less efficient if implemented in software.

The Feistel-like structure 3100 preferably utilizes CKR 3110 to integrate a round key with a right half of a state and the function CRL 3120 to combine the result of the key integration with a left half of the state. The left and right halves of the state are referred below as L and R, respectively.

Reference is now made to FIG. 9, which is an illustration of a Combine Key RightPart (CKR) function 3110 comprised in the hardened Feistel-like structure of FIG. 8.

The CKR function 3110 preferably comprises the following operations:

1. RExp (Right Part Expansion) 3210 preferably expands the right half R from 64 to 100 bits;

2. Using a XOR operation 3220, a 100 bit round key, RKᵢ, is preferably combined with the expanded 100 bit right half;

3. MCF (Mix and Condense Function) 3230 preferably mixes the 100 bit result of RExp 3210 and, preferably in a pseudorandom fashion, preferably condenses the mixed 100 bits to 64 bits.

Reference is now made to FIG. 10, which is an illustration of a preferred implementation of hardware for a RightPart Expansion Function comprised in the Combine Key RightPart function of FIG. 9. It is appreciated that FIG. 10 provides an illustration of a preferred implementation of hardware structures and methods for implementing an expansion function, the illustration being drawn in a format which is well known in the art. RExp 2310 (FIG. 9) preferably uses a linear transformation to expand the 64 bit R into a 100 bit expanded RightPart, where each of the 100 bit output bits is the result of a XORing of 2 or 3 input bits.

Indices implemented in the proposed hardware of FIG. 10 are preferably selected pseudo-randomly with the following constraints:

1. Each one of the 64 input bits of the R preferably influences at least two output bits;

2. Each bit of the 100 bit round key preferably influences exactly one output bit;

3. Indices are preferably selected so as to be spread equally between the input and output bits, thereby avoiding a situation where a small number of input bits influence only a small number of output bits; and

4. Any small set of input bits preferably influences a larger set of output bits.

Those skilled in the art will appreciate that error correcting codes, such as the well known Hamming error correcting code, share similar design criteria with the indices implemented in the proposed hardware and thus, error correcting codes may be well suited for use as the indices implemented in the proposed hardware.

It is preferable that the RExp function 3210 (FIG. 9) and the subsequent XOR 3220 operation (with the round key) balance between a proper mixing of the round key with the right part and a time-efficient implementation of the mixing, thereby allowing a hardware implementation of both the RExp function 3210 (FIG. 9) and the XOR 3220 operation that preferably comprises only two layers of XOR operations (and, in some preferred embodiments, an additional layer of NOT gates).

Returning to the discussion of FIG. 9, the MCF function 3230 is now discussed. The 100 bit expanded right half, after XORing with the 100 bit round key RKᵢ, is preferably input into the MCF function 3230. A 100 bit result of the XORing is preferably reduced and condensed into a 64-bit temporary result, which is used later as a control input of the CRL function (described with reference to FIG. 12). The MCF function 3230 is preferably critical in making the Feistel-like structure 3100 (FIG. 8) emulation resistant.

Reference is now made to FIG. 11, which is an illustration of a preferred embodiment of the mini-function, the mini-function serving as a building block for the MCF function 3230 (FIG. 9) comprised in the CKR function 3110 of FIG. 9.

The MCF function preferably uses between round key generation function and 50, inclusive, layers of mini-functions 3400, where each of the mini-functions 3400 preferably comprises two micro-functions, a balanced micro-function BF 3410 and a non-linear micro-function NLF 3420.

A balanced micro-function BF 3410 is defined as follows: a set of the input bits for the balanced function are denoted as the balancing set and for every selection of the other input bits, a uniform distribution on the balancing set-guarantees uniform distribution on the output (i.e., a uniform distribution of zeros and ones input guarantees a uniform distribution of zeros and ones output). For example and without limiting the generality of the foregoing, a XOR operation is a balanced function for which each of the input bits is a balancing set.

The mini-functions 3400 are preferably designed as follows:
the input bits are preferably input into a splitter 3415, which splits the balancing set of bits from the other input bits;
NLF 3420 is preferably executed on the other input bits; and
afterwards BF 3410 is preferably executed on the output of NLF 3420 and on the balancing set of bits, received from the splitter 3415.

In some preferred embodiments, the balancing set of bits goes through a third type of micro-functions, comprising an invertible transformation, such as a 2 bit-to-2 bit S-box, where the balancing set comprises 2 bits. Putting the balancing set through the invertible transformation is preferably performed simultaneously with the NLF, and thus, employing the third micro-function can be performed preferably without cost in execution time.

For example and without limiting the generality of the foregoing, the following functions process 3-bit inputs (according to the design criteria stated immediately above):
(input1 [symbol] input2)⊕input3;
NOT ((input1 [symbol] input2)⊕(input3);
The Majority function; and
MUX, where a single bit selects which of the two other input bits to output.

The mini-functions 3400 in layer i preferably receive inputs from the outputs of the mini-functions 3400 in layer i−1. Selection of which output of layer i−1 goes to which input of layer i is preferably performed in a manner that preferably maximizes the mixing between layers and thus preferably avoids localization effects.

It is preferable that the exact MCF 3230 (FIG. 9) utilized is automatically generated during design. However, the MCF utilized preferably passes several statistical tests measuring correlation between output bits (in particular, linear correlations). The statistical tests are preferably not restricted to input and output, but preferably also measure correlations in internal layers between inputs and outputs. In addition, it is preferable that it is not possible to express any small set of output bits of MCF 3230 (FIG. 9) as a short expression of input bits of MCF 3230 (FIG. 9).

Reference is now made to Appendix A, which is a description of a method for robust cipher design, comprising a preferred method of key expansion and set up and a preferred implementation of a round key encryption function, the method of Appendix A comprising a preferred implementation of the Feistel-like structure of FIG. 8. In order to harden the Feistel-like structure 3100 (FIG. 8) and prevent single points of failure, MCF 3230 (FIG. 9) preferably is implemented in two versions. The two versions are preferably used in an alternating manner throughout the rounds of the Feistel-like structure 3100 (FIG. 8). It is appreciated that even if one of the two versions is found to be “faulty”, the Feistel-like structure 3100 (FIG. 8) as a whole preferably remains strong. A “faulty” function in the present context is either a cryptographically weak function (e.g., having strong linear or differential properties) or a function that is easy to emulate in software.

Reference is now made to FIG. 12, which is an illustration of a Combine RightPart Combine LeftPart (CRL) function 3120 comprised in the hardened Feistel-like structure 3100 of FIG. 8. The CRL 3120 function combines the 64-bit result of the MCF 3230 as the last stage of the CKR 3110 with the unchanged 64-bit left half Lᵢ to get a new 64-bit pseudo-random right half, Rᵢ₊₁.

The CRL function 3120 preferably complies with the following design criteria:

1. CRL 3120 is preferably invertible in a second parameter when fixing a first parameter. That is, there shall be ICRL, such that, for every X, Y, ICRL(X, CRL(X, Y))=Y, where the CKR 3110 result is used as the first parameter X (also denoted hereinafter as the “control input”) and the left half, Lᵢ, is used as the second parameter Y (also denoted hereinafter as the “transform input”).

2. CRL 3120 is preferably not an involution. That is, ICRL preferably differs significantly from CRL 3120 (as opposed, for example, to the XOR function that is used in DES).

The CRL function 3120 preferably comprises two stages, each stage working on small sub-blocks. In a preferred embodiment, each sub-block comprises 4 bits. After each of the stages, a permutation is preferably applied to the result, breaking any locality effect of working on small sub-blocks.

The first stage comprises a linear layer LL 3510 that mixes the control input with the transform input.

After LL 3510, a bit-permutation PL 3520 is preferably applied to the result of the LL 3510.

Afterwards, the output of PL 3520 is preferably input into an S-boxes layer SL 3530, comprised of sixteen 4-bit to 4-bit S-boxes.

Finally, a bit-permutation (not depicted) is preferably applied to the output of SL 3530.

Reference is now made to FIG. 13, which an illustration of one preferred implementation of the linear layer 3510 in the Combine RightPart Combine LeftPart (CRL) function 3120 of FIG. 12. LL 3510 comprises a first splitter 3610 which splits transform input, Lᵢ, into 4-bit micro-blocks. Similarly, a second splitter splits control input into 4-bit micro-blocks. The 4-bit micro-blocks resulting from the control input are preferably used to determine a linear transformation (LT). The determined transformation is preferably applied to the input 4-bit micro-blocks, thereby producing a 4-bit output micro-block. Linear transform operations of the control data 4-bit micro-blocks and the transform data 4-bit micro-blocks are depicted in FIG. 13 as “LT”.

For the control bits C[0.3] and the input bits I[0.3] the linear transformation preferably O=(A(C)×I)⊕C where A(C) is a linear transformation depending on control input C:

$$A ( C ) = [ \begin{matrix}{A}_{11} ( C ) & {A}_{12} ( C ) & {A}_{13} ( C ) & {A}_{14} ( C ) \\ {A}_{21} ( C ) & {A}_{22} ( C ) & {A}_{23} ( C ) & {A}_{24} ( C ) \\ {A}_{31} ( C ) & {A}_{32} ( C ) & {A}_{33} ( C ) & {A}_{34} ( C ) \\ {A}_{41} ( C ) & {A}_{42} ( C ) & {A}_{43} ( C ) & {A}_{44} ( C )\end{matrix} ]$$

for Aᵢⱼs which are 4 bit-to-1 bit functions which are applied to the control input, and O is the resulting output.
A(C) is invertible; that is there exists B(C), such that:

$$B ( C ) = [ \begin{matrix}{B}_{11} ( C ) & {B}_{12} ( C ) & {B}_{13} ( C ) & {B}_{14} ( C ) \\ {B}_{21} ( C ) & {B}_{22} ( C ) & {B}_{23} ( C ) & {B}_{24} ( C ) \\ {B}_{31} ( C ) & {B}_{32} ( C ) & {B}_{33} ( C ) & {B}_{34} ( C ) \\ {B}_{41} ( C ) & {B}_{42} ( C ) & {B}_{43} ( C ) & {B}_{44} ( C )\end{matrix} ]$$

$$A ( C ) \times B ( C ) = [ \begin{matrix}1 & 0 & 0 & 0 \\ 0 & 1 & 0 & 0 \\ 0 & 0 & 1 & 0 \\ 0 & 0 & 0 & 1\end{matrix} ] ;$$

such that for every control input C: that is A(C) is the inverse of B(C).

In preferred embodiments A(C) comprises:

$$[ \begin{matrix}{A}_{11} ( C ) & {A}_{12} ( C ) & {A}_{13} ( C ) & {A}_{14} ( C ) \\ {A}_{21} ( C ) & {A}_{22} ( C ) & {A}_{23} ( C ) & {A}_{24} ( C ) \\ {A}_{31} ( C ) & {A}_{32} ( C ) & {A}_{33} ( C ) & {A}_{34} ( C ) \\ {A}_{41} ( C ) & {A}_{42} ( C ) & {A}_{43} ( C ) & {A}_{44} ( C )\end{matrix} ] = \\ [ \begin{matrix}1 & C [ 0 ] & 0 & 0 \\ 0 & 1 & C [ 1 ] & 0 \\ 0 & 0 & 1 & C [ 2 ] \\ 0 & 0 & 0 & 1\end{matrix} ] \times [ \begin{matrix}1 & 0 & 0 & 0 \\ C [ 1 ] & 1 & 0 & 0 \\ 0 & C [ 2 ] & 1 & 0 \\ 0 & 0 & C [ 3 ] & 1\end{matrix} ] \qquad ( equation 1 )$$

It is appreciated that if the transformation A(C) is used during decryption, then during encryption the inverse transformation of A(C) is used. In particular, if A(C) is as described in equation 1, then, since both matrices comprising control bits used in equation 1 are involutions, the inverse transformation B(C) is the composition of the transformations in reversed order. The results of all linear transformations are preferably input into join function 3630. Join function 3630 preferably joins the results of all 16 linear transformations into one 64 bit value.

The 64 bit output of join function 3630 is preferably input into bit-permutation PL 3520, thereby producing a 64 bit permuted output. Bit-permutations are well known cryptographic structures.

Reference is now made to FIG. 14, which is an illustration of one preferred implementation of an S-boxes layer in the Combine RightPart Combine LeftPart (CRL) function 3120 of FIG. 12. The layer of S-boxes SL 3530 (FIG. 12) preferably comprises 4-bit to 4-bit S-boxes, which are preferably simple to implement in hardware and still comprise a significant contribution to non-linearity of the hardened Feistel-like structure 3100 (FIG. 8). The 64-bit input is input into an S-box splitter 3710. The S-box splitter 3710 preferably divides the 64-bit input into 16 4-bit micro-blocks. The 16 4-bit micro-blocks go through sixteen S-boxes 3720. Output from the sixteen S-boxes 3720 is all mixed in a bit permutation join function 3730.

The specification of the Serpent cipher (refer to www.ftp.cl.cam.ac.uk/ftp/users/rja14/serpent.pdf) describes eight 4 bit-to-4 bit S-boxes, which were optimized against linear and differential attacks. It is the opinion of the inventors of the invention that the S-boxes described in the specification of the Serpent cipher should preferably be used in the hardened Feistel structure 3100 (FIG. 8) described herein. Reference is now made to Appendix B which is a copy of Appendix A.5 of the Serpent Cipher specification, describing S-boxes S₀ through S₇ of the Serpent Cipher.

Reference is now made to FIG. 15, which is an illustration of one preferred implementation of a key expansion function 3800 comprised in the hardened Feistel-like structure 3100 of FIG. 8. The key setup function 3800 preferably extends a 128-bit key to RN 100-bit round keys (RN is the number of rounds). The key expansion function is preferably designed according to the following principles:

1. Preferably reuse available hardware functions.

2. Preferably enhance robustness of the hardened Feistel-like structure 3100 (FIG. 8), as discussed above, with reference to the discussion of Appendix A.

3. Preferably allow both forward and backward generation of the round keys.

As discussed above, with reference to the discussion of Appendix A, the key expansion function 3800 takes advantage of the fact that the MCF preferably comprises two variations; one variation is preferably active during any round in the MCF function for the CKR 3110 (FIG. 9), while the other variation is preferably available for use. The key expansion function 3800 therefore preferably uses the available MCF function in order to generate the round keys in a cryptographically secure manner.

Imitating a typical design for stream ciphers, the key setup function 3800 preferably employs two functions; a first function, state update 3810, is preferably operative to update a state. The second function, round key generation 3830, preferably derives a new round key 3840 from the new state. The state update 3810 and round key generation 3830 functions are executed in an alternating order generating round keys 3840 which are preferably cryptographically decoupled from the key itself, as well as from each other.

The state of the key setup is preferably a 128-bit shift register. The 128-bit shift register is initialized 3850 with the 128-bit key. The state update function 3810 preferably comprises a circular rotation of the 128-bit register. It is appreciated that the number of rounds (RN) is preferably smaller than the size of the 128-bit register, and thus the state update function preferably does not loop during a round.

During decryption, in order to get the round keys in the proper order (reverse order from the order used during encryption), a decrypter preferably receives the state in reverse order used during encryption. In some preferred embodiments, decryption preferably begins with shifting the shift register as many times as needed in order to get the state appropriate for the last round key. Each subsequent round then preferably shifts the state in the opposite direction to the direction used to circularly shift the state during encryption.

It is appreciated that replacement of a short LFSR (left shift register) with 2-3 smaller LFSRs may be preferable. If 2-3 smaller LFSRs are utilized, the decryption key is the result of applying a linear transformation (calculated in advance and hard-wired) on the encryption key, and then the LFSRs are preferably rolled back to get the round keys in the reverse order.

In order to avoid weak keys and slide attacks, an additional XOR with a predefined round string may preferably be applied after the state update function 3810.

Reference is now made to FIG. 16, which is an illustration of one preferred implementation of round key generation 3830 utilizing the Mix and Condense function (MCF) 3230 (FIG. 9) in the key expansion function 3800 of FIG. 15. The round key generation 3830 function inputs the 128-bit state into the MCF 3230 (FIG. 9) and takes the 100-bit output as the next round key, as discussed above with reference to Appendix A.

The following are design principles for selecting the order of using the MCF variations in the key setup and the round operation:

1. Preferably allow a smooth pipeline between the round operation and the key setup. Specifically, have both functions active together where one generates the key for the next round and the other is used for the round operation itself.

2. Preferably use as many different combinations as possible, maximizing the distribution of the “responsibility” for both security and emulation resistance.

As discussed in greater detail in Appendix A, for two MCF functions A and B, the round operation preferably uses A and B in the following order: A A B B A A B B A A B B A A B B . . . .

The key setup operation uses the function that is left available, i.e., B on rounds 1, 2 (preparing the keys for round 2, 3), A on round 3, 4 (preparing the key for round 4, 5) etc.

Thus the rounds of the hardened Feistel-like structure 3100 (FIG. 8) have the following combinations as round key derivation and round operation:

Round 4t+1: AA;

Round 4t+2: BA;

Round 4t+3: BB; and

Round 4t+4: AB.

Alternative preferred implementations are discussed at length in Appendix A.

The implementation of MCF 3230 (FIG. 9) that is preferably used in the round operation and the MCF that is used in the key expansion have different sizes of inputs and outputs. Specifically, a 128 bit value is preferably input in order to produce a 100 bit output for key setup, and a 100 bit value is preferably input in order to produce a 64 bit output for a round operation.

In order to use the same hardware for both operations, the implemented MCFs are preferably implantations of 100 bits going to 128 bits going to 100 bits going to 64 bits, where most of the layers are in the 128 bits going to 100 bits part. Thus, the round operation uses the whole function and the key expansion uses only the middle part of the function. The blowing effect herein described also contributes to preferably making the function hard to emulate in software.

Reference is now made to FIGS. 17 to 20, which are simplified flowchart illustrations of preferred alternative methods of operation of the hardened Feistel-like structure of FIG. 8, in accordance with preferred embodiments thereof. The methods of FIGS. 17 to 20 are believed to be self explanatory with reference to the above discussion.

Reference is now made to Appendix C, which comprises a description of certain alternative preferred embodiments for use with the present invention.

It is appreciated that software components of the present invention may, if desired, be implemented in ROM (read only memory) form. The software components may, generally, be implemented in hardware, if desired, using conventional techniques.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

### APPENDIX A

### Robust Cipher Design

### BACKGROUND

Block ciphers are a well known family of symmetric key-based ciphers. Block ciphers operate on plain text in groups of bits. The groups of bits are referred to as blocks. Block ciphers are dealt with at length in Chapters 12-15 of Applied Cryptography, Second Edition, by Bruce Schneier, published by John Wiley and Sons, 1996. Many block ciphers are constructed by repeatedly applying a function. Such block ciphers are known as iterated block ciphers. An iteration of the block cipher is termed a round, and the repeated function is termed a round function. The number of times the round is repeated in an iterated block cipher is referred to as a round number (RN).

One block cipher, DES, is specified in FIPS 46-3, available on the Internet at: csrc.nist.gov/publications/fips/fips46-3/fips46-3.pdf. FIPS 46-3 is hereby incorporated herein by reference.

A second well known block cipher, AES, is specified in FIPS 197, available on the Internet at: csrc.nist.gov/publications/fips/fips197/fips-197.pdf. FIPS 197 is hereby incorporated herein by reference.

The disclosures of all references mentioned above and throughout the present specification, as well as the disclosures of all references mentioned in those references, are hereby incorporated herein by reference.

### SUMMARY

The system and method described in this Appendix seeks to provide an improved method and system for cipher design.

There is thus provided a system providing a first function Fᵢ and a second function Fⱼ, providing a round key generation function, the round key generation function being operative to utilize, in any given round, exactly one of the first function Fᵢ, and the second function Fⱼ, providing a round mixing function, the round mixing function being operative to utilize, in any given round, exactly one of the first function Fᵢ, and the second function Fⱼ, utilizing the round key generation function in at least a first round to generate a second round key for use in a second round, and utilizing the round mixing function in at least the first round to mix a first round key with a cipher state, wherein one of the following is performed in the first round the round key generation function utilizes the first function Fᵢ to generate the second round key for use in the second round, substantially simultaneously with the round key mixing function utilizing the second function Fⱼ to mix the first round key with the cipher state, and the round key generation function utilizes the second function Fⱼ to generate the second round key for use in the second round, substantially simultaneously with the round key mixing function utilizing the first function Fᵢ to mix the first round key with the cipher state.

### BRIEF DESCRIPTION OF THE DRAWINGS

The present Appendix will be understood and appreciated more fully from the following detailed description, taken in conjunction with the drawings in which:

FIG. 21 is a simplified block diagram illustration of a system for robust cipher design for use with a preferred embodiment of the present invention;

FIG. 22 is a time line showing one preferred implementation of the relationship between key expansion and encryption rounds in a cipher designed according to the method of FIG. 21;

FIG. 23 is a simplified block diagram illustration depicting the use of MUX and DEMUX modules in a preferred implementation of the method of FIG. 21;

FIG. 24 is a simplified block diagram illustration of a preferred implementation of a round key generation function operative to generate round keys in a cipher designed according to the method of FIG. 21;

FIG. 25 is a simplified block diagram illustration of four rounds of a typical Feistel block cipher constructed and operative in accordance with the system of FIG. 21;

FIG. 26 is a simplified block diagram illustration of four rounds of a typical AES-like block cipher constructed and operative in accordance with the system of FIG. 21;

FIG. 27 is a simplified block diagram illustration of eight rounds of a typical Feistel block cipher constructed and operative in accordance with an alternative preferred embodiment of the system of FIG. 21;

FIG. 28 is a simplified block diagram illustration of eight rounds of a typical AES-like block cipher constructed and operative in accordance with an alternative preferred embodiment of the system of FIG. 21;

FIG. 29 is a simplified block diagram illustration of eight rounds of a typical Feistel block cipher constructed and operative in accordance with yet another alternative preferred embodiment of the system of FIG. 21; and

FIG. 30 is a simplified block diagram illustration of eight rounds of a typical AES-like block cipher constructed and operative in accordance with yet another alternative preferred embodiment of the system of FIG. 21.

### DETAILED DESCRIPTION OF A PREFERRED EMBODIMENT

Reference is now made to FIG. 21, which is a simplified block diagram illustration of a system 1010 for robust cipher design for use with a preferred embodiment of the present invention. The system 1010 of FIG. 21 comprises different instances of a function F, depicted in round n as Fₐ and F_{b}. In round n+1, the different instances of function F are depicted as F_{c} and F_{d}.

The function F, in preferred embodiments thereof, preferably comprises at least one of:

a significant portion of cipher security (that is to say that if F is poorly selected, a cipher comprising F may be insecure); and

a significant portion of hardware complexity of a typical hardware implementation of the cipher composing F (the inventors of the present invention anticipate that at least 10% and preferably 20% of the gates in the hardware implementation of the cipher comprising F are dedicated to the function F, or at least 10% and preferably 20% of the voltage of the hardware implementation of the cipher comprising F is dedicated to the function F).

In preferred embodiments of a cipher comprising the function F, the function F, therefore, preferably comprises a significant portion of cipher security and comprises a significant portion of the hardware implementation of the cipher.

For example and without limiting the generality of the foregoing, the function F may preferably comprise a layer of S-boxes (well known cryptographic structures), such as the AES invertible 8-bit-to-8-bit S-boxes, or DES non-invertible 6-bit-to-4-bit S-boxes. Alternatively, the function F may comprise a linear transformation such as the AES ShiftRows transformation function, or the AES MixColumns transformation function.

Preferred methods of implementation are discussed below with reference to FIGS. 25-30.

The system of FIG. 21 also comprises a round key generation function 1020, depicted in round n as comprising the first function, Fₐ, and later depicted in round n+1 as comprising the second function, F_{c}. The system of FIG. 21 also comprises a round mixing function 1030, depicted in round n as comprising a third function, F_{b}, and later depicted in round n+1 as comprising a fourth function, F_{d}. Fₐ, F_{b}, F_{c}, and F_{d} are preferably selected from among two functions, Fᵢ and Fⱼ, thereby allowing implementation of only the two functions, Fᵢ and Fⱼ for the four functions, Fₐ, F_{b}, F_{c}, and F_{d}. In some preferred embodiment, F_{b} and F_{c} are not identical, and thus can preferably be executed substantially simultaneously. That is, either F_{b}=Fᵢ and F_{c}=Fⱼ, or F_{b}=Fⱼ and F_{c}=Fᵢ. In any event, the functions Fₐ and F_{d} can be either of functions Fᵢ or Fⱼ.

The operation of the system of FIG. 21 is now briefly described, making additional reference to FIG. 22, which is a time line showing one preferred implementation of the relationship between key expansion (note that the terms “key expansion” and “key generation” are used interchangeably in the present disclosure and figures) and encryption rounds in a cipher designed according to the method of FIG. 21. Prior to round 1, the round key generation function 1020 produces a round key for use by the round mixing function 1030 in round 1. Substantially in parallel to the operation of the round mixing function 1030 in round 1, the round key generation function 1020 produces a round key for use by the round mixing function 1030 in round 2. The process of the round key generation function 1020 producing a round key for use by the round mixing function 1030 in the next round continues substantially in parallel to the operation of the round mixing function 1030 until in round rounds number−1 (RN−1), the round key generation function 1020 produces a round key for use by the round mixing function 1030 in round RN. During round RN, there is no next round, and thus, while the round mixing function 1030 operates using the round key produced by the round key generation function 1020 during round RN−1, the round key generation function 1020 preferably does not generate a key.

The different instances of F, Fₐ and F_{b}, are preferably implemented only once, preferably in hardware. It is appreciated that Fₐ and F_{b} may, under some circumstances, also be implemented in software.

Those skilled in the art will appreciate that implementing the functions Fₐ and F_{b} in hardware, instead of implementing a single function in hardware, requires additional gates in the hardware, and additional voltage in order to power the gates. In order to more efficiently implement the two instances of F, when Fₐ is operating as part of round mixing function 1030, F_{b} preferably is operating as part of the round key generation function 1020 for the next round. Similarly, when F_{b} is operating as part of round mixing function 1030, Fₐ preferably is operating as part of the round key generation function 1020 (FIG. 21) for the next round.

Reference is now made to FIG. 23, which is a simplified block diagram illustration depicting the use of MUX and DEMUX modules in a preferred implementation of the method of FIG. 21. In a preferred implementation, a MUX module and a DEMUX module are preferably operative to differentiate between different sources for input, a key expansion input or an input as part of the round, as well as the different outputs, a register for round keys or a round key state register. The MUX modules are preferably updated by a counter (not depicted) which is operative to count rounds.

Hardware comprising key expansion logic 1310 outputs a temporal result to a first MUX module 1320. Similarly, hardware comprising round encryption logic 1330 outputs a temporal result to the first MUX module 1320. The first MUX module 1320, based on selection criteria 1340, determines if the output of the MUX module 1320 has to be a value taken as MUX input from the key expansion logic 1310 hardware or the value taken as MUX input from the round encryption logic 1330 hardware. A preferred implementation, given by way of example, relevant for the discussion below of FIGS. 29 and 30, of the selection criteria 1340 comprises a counter ranging in value from 0 to 3. If the counter value is 0 or 1, one option is implemented by the MUX module. If the counter value is 2 or 3, the second option is implemented by the MUX module. Output from the MUX module 1320 is preferably sent to Fᵢ as appropriate for a particular round. Output from Fᵢ is preferably input into a DEMUX module 1360. The DEMUX module 1360 preferably applies the selection criteria 1340 to determine if the received input needs to be preferably output as a round key generation temporal result 1370 to the key expansion logic 1310 hardware or as a round key mixing temporal result 1380 to the round encryption logic 1330 hardware.

In some preferred embodiments, key expansion logic 1310 has a MUX component (not depicted) which selects between the round key generation temporal result 1370 of Fᵢ and the round key mixing temporal result 1380 of Fⱼ. Similarly, in such preferred embodiments, the round encryption logic 1330 has a MUX component (not depicted) which selects between the round key generation temporal result 1370 of Fⱼ and the round key mixing temporal result 1380 of Fᵢ.

A design similar to the system of FIG. 23 comprises a preferred embodiment of MUX and DEMUX selection logic for Fⱼ, where the selection criteria 1340 that is used for Fⱼ is preferably the negation of the selection logic that is used for Fᵢ. That is, when the function Fᵢ is used for round key generation, function Fⱼ is preferably used for round key mixing, and vice-versa.

Those skilled in the art will appreciate that in addition to the benefit of added efficient use of voltage, a cipher designed as described herein also has additional security in that if, for instance, Fⱼ is found to be weak (for example and without limiting the generality of the foregoing, Fⱼ comprises linear properties; or Fⱼ comprises differential properties), Fᵢ still preferably gives some measure of protection to the cipher.

In some preferred embodiment, the function F is deliberately designed to be inefficient in any implementation, except for an implementation comprising specialized hardware, thereby making a cipher comprising the function F inefficient in any implementation, except for an implementation comprising specialized hardware. Therefore, a cipher designed so as to comprise such an embodiment of the function F in Fᵢ and in Fⱼ, Fᵢ being is inefficient, except for an implementation comprising specialized hardware, and Fⱼ not being inefficient in an implementation not comprising specialized hardware, comprises an implementation of the cipher which is still, substantially inefficient except for an implementation comprising specialized hardware.

In order to differentiate between multiple usages of Fᵢ (in the round mixing function 1030 (FIG. 21) and in the round key generation function 1020 (FIG. 21)), constant round vectors may preferably be used in order to affect the behavior of function Fᵢ. Similarly, in order to differentiate between multiple usages of Fⱼ (in the round mixing function 1030 (FIG. 21) and in the round key generation function 1020 (FIG. 21)), constant round vectors may preferably be used in order to affect the behavior of function Fⱼ. Constant round vectors may preferably be used for at least one of two purposes:

1. allowing more versions of F than are implemented in hardware (for instance, implement Fᵢ and Fⱼ, and use different constant vectors during different rounds in order to increase differences in outputs of different rounds); and

2. differentiating between usage of either Fᵢ or Fⱼ as a round operation and using Fᵢ and Fⱼ as a key expansion operation by using a different constant round vector during key expansion than during the round operation.

The use of functions Fᵢ and Fⱼ as part of the round key generation function and as part of the round mixing function in cipher design is now discussed. Reference is now made to FIG. 24, which is a simplified block diagram illustration of a preferred implementation of a round key generation function operative to generate round keys in a cipher designed according to the method of FIG. 21. Fᵢ and Fⱼ may comprise either invertible functions or non-invertible functions, as appropriate, depending on the cipher in which functions Fᵢ and Fⱼ are implemented, and on the stage of implementing the cipher in which functions Fᵢ and Fⱼ are implemented. As will be discussed below with reference to FIGS. 25, 27, and 29, in Feistel based encryption schemes, such as DES, Fᵢ and Fⱼ (as part of the key mixing mechanism) preferably comprise a part of the combination of the round key with “right” half, prior to combining (XORing in DES) with the “left” half (a non-invertible operation). In such a cipher, functions Fᵢ and Fⱼ are preferably implemented as non-invertible functions. Alternatively and preferably, as described below with reference to FIGS. 26, 28, and 30, in substitution permutation ciphers such as the AES cipher (FIPS 197), Fᵢ and Fⱼ preferably comprise part of the round function. In such a cipher, functions Fᵢ and Fⱼ are preferably implemented as invertible functions.

The round key generation function 1327 operates iteratively in order to generate a plurality of keys. The iterative operation of round key generation function 1327 comprises a state, R. The state R is initialized by executing a function, StateInit 1337, with root key K as input during every round. R is updated by a State Update function 1347. The State Update function 1347 is applied to the state from the previous round in order to update R for the round. A Round Key Generation function 1357 generates a new round key RKᵢ 1367 from the updated value of R. Thus, round keys RK₁ through RK_{RN} (RN=round number, the number of rounds, as described above) are generated from root key K according to the following method:

R₀=InitState(K)

For i=1 to RN
Rᵢ=StateUpdate(Rᵢ₋₁)
RKᵢ=RoundKeyGenerate(Rᵢ)
   In preferred embodiments, the size of the state R is preferably equal to the size of the key. For example and without limiting the generality of the foregoing, if the key is 128 bits, the state R is preferably 128 bits.

One preferred method of determining the state during the iterative process described above, applicable when RN is less than the size of the key in bits, comprises initializing an L-bit state with an L-bit key K, and circularly shifting the L bit key one bit each round. In such a method of determining the state, RoundKeyGenerate 1357 need not be an invertible function.

In preferred implementations where Fᵢ and Fⱼ comprise non-invertible functions, and the round key generation function is designed as described above, non-invertible function F preferably comprises a portion of the RoundKeyGenerate 1357 function. In preferred implementations where Fᵢ and Fᵢ comprise invertible functions, and the round key generation function is designed as described above, the StateUpdate 1347 function is preferably invertible, and invertible function F preferably comprises a portion of the StateUpdate 1347 function.

Non-limiting examples of different preferred implementations are now described.

Reference is now made to FIG. 25, which is a simplified block diagram illustration of four rounds of a typical Feistel block cipher 1400 constructed and operative in accordance with the system of FIG. 21. It is appreciated that FIG. 25 provides an illustration of data structures and methods for implementing an encryption network, the illustration being drawn in a format which is well known in the art.

The Feistel block cipher 1400 comprises round mixing function designated hereinafter as function A 1420 and function B 1430. Additionally, a combine function 1440, depicted in FIG. 21 as δ,XOR (exclusive OR), combines the output of either of function A 1420 or of function B 1430 with an input. Even though the combine function 1440 is depicted as XOR, it is appreciated that any appropriate combining function may be implemented to combine the output of either of function A 1420 or of function B 1430 with the input.

The operation of the system of FIG. 25 is now described. As is well known in the art, block ciphers typically are applied in an iterative fashion, an iteration of the cipher being referred to as a “round”. A function which is repeated during each round is typically referred to as a “round function”. Frequently, the round function comprises several sub-functions.

For example and without limiting the generality of the foregoing, the well known in the art DES block cipher (a Feistel cipher) round function comprises four stages, each stage executed in an appropriate sub-function:

1. Expansion, in which a 32-bit input block is expanded to 48 bits;

2. Key mixing, in which a 48-bit output of the expansion is combined, using a XOR function, with a round key 1450, the round key 1450 being specific to a specific round;

3. Substitution, in which an output of the key mixing function is subdivided into 8 6-bit sub-blocks. Each of the 8 6-bit sub-blocks is input into a substitution box (“S-box”), which, according to a non-linear transformation, outputs a 4-bit block, thereby producing a total of 32 output bits; and

4. Permutation, in which the 32 output bits of the substitution are rearranged according to a fixed permutation, the “P-box”.

In certain preferred embodiments, a function, F, operative as a sub-function comprised in the round function of the block cipher 1410 is replaced with different instances of F: Fᵢ and Fⱼ. During different rounds of the block cipher 1410, the different instances of F (Fᵢ and Fⱼ), are used. Thus, in the preferred embodiment depicted in FIG. 25, function A 1420, comprising function Fᵢ, and function B 1430, comprising function Fⱼ, are used in alternate rounds.

Since the round encryption function preferably uses a round key generated during a previous round, it is appreciated that during rounds when function A 1420, comprising function Fᵢ, comprises the round mixing function, Fⱼ is preferably used in the round key generation function to generate the round key for the next round. During rounds when function B 1430, comprising function Fⱼ, comprises the round mixing function, Fᵢ is preferably used in the round key generation function to generate the round key for the next round.

In the cipher depicted in FIG. 25, each sequence of rounds comprises ABAB . . . , such that each round alternates the use of the implementation of F (Fᵢ, Fⱼ, Fᵢ, Fⱼ, . . . ). In such a preferred implementation, key expansion preferably comprises XBABA . . . , where a first round uses a key, X, that can be derived either from A or B. Thus, the following table describes the preferred implementation depicted in FIG. 25:

| Round | Key Generation | Round Function |
|---|---|---|
| 1 | X | Fᵢ |
| 2 | Fⱼ | Fⱼ |
| 3 | Fᵢ | Fᵢ |
| 4 | Fⱼ | Fⱼ |
| 5 | Fᵢ | Fᵢ |

Reference is now made to FIG. 26, which is a simplified block diagram illustration of four rounds of a typical AES-like block cipher 1500 constructed and operative in accordance with the system of FIG. 21. Each round of the AES-like block cipher comprises a round key generation function 1510 (for ease of depiction, “key setup”, in FIG. 26) operative to provide the round key to the round mechanism 1520. Each round mechanism 1520 typically comprises a key mixing function 1530 (for ease of depiction, “key comb”, in FIG. 26), which is operative to receive the key from the round key generation function 1510, and combine, typically using a XOR function, the key with a known constant. Output from the key mixing function 1530 is typically input into a linear layer 1540. The linear layer 1540 typically comprises functions well known in the art, such as “MixRows” and “ShiftColumns”. Output from the linear layer 1540 is typically input into a non-linear layer 1550. The non-linear layer 1550 typically comprises S-boxes. Additionally, in preferred embodiments, the non-linear layer 1550 comprises an implementation of the function F, either Fᵢ or Fⱼ. In the preferred implementation depicted in FIG. 26, implementations of Fᵢ or Fⱼ alternate, similar to the preferred implementation depicted in FIG. 25.

Reference is now made to FIG. 27, which is a simplified block diagram illustration of eight rounds of a typical Feistel block cipher constructed and operative in accordance with an alternative preferred embodiment of the system of FIG. 21. Reference is additionally made to FIG. 28, which is a simplified block diagram illustration of eight rounds of a typical AES-like block cipher constructed and operative in accordance with an alternative preferred embodiment of the system of FIG. 21.

The operation of the systems depicted in FIG. 27 is described above with reference to FIG. 25, and the operation of the systems depicted in FIG. 28 is described above with reference to FIG. 26.

In the ciphers depicted in FIGS. 27 and 28, each sequence of several rounds first comprises function Fᵢ in the round mixing function and comprises the function Fⱼ in the round key generation function. Then, after the sequence of several rounds, functions Fᵢ and Fⱼ switch roles, and function Fᵢ is comprised in the round key generation function, and function Fⱼ is comprised in the round mixing function. Thus, the following table describes the preferred implementation depicted in FIGS. 27 and 28:

| Round | Key Generation | Round Function |
|---|---|---|
| 1 | X | Fᵢ |
| 2 | Fⱼ | Fᵢ |
| . . . | Fⱼ | Fᵢ |
| n | Fⱼ | Fᵢ |
| n + 1 | Fⱼ | Fᵢ |
| n + 2 | Fⱼ | Fⱼ |
| n + 3 | Fᵢ | Fⱼ |
| . . . | Fᵢ | Fⱼ |
| n + m | Fᵢ | Fⱼ |
| n + m + 1 | Fᵢ | Fⱼ |
| n + m + 2 | Fᵢ | Fⱼ |

Reference is now made to FIG. 29, which is a simplified block diagram illustration of eight rounds of a typical Feistel block cipher constructed and operative in accordance with yet another alternative preferred embodiment of the system of FIG. 21. Reference is additionally made to FIG. 30, which is simplified block diagram illustration of eight rounds of a typical AES-like block cipher constructed and operative in accordance with yet another alternative preferred embodiment of the system of FIG. 21.

The operation of the systems depicted in FIG. 29 is described above with reference to FIG. 25, and the operation of the systems depicted in FIG. 30 is described above with reference to FIG. 26.

In the ciphers depicted in FIGS. 29 and 30, two rounds comprise function Fᵢ in the round key generation function and comprise the function Fⱼ in the round mixing function. Then, after the two rounds, functions Fᵢ and Fⱼ switch roles, and for the next two rounds, function Fᵢ is comprised in the round key generation function, and function Fⱼ is comprised in the round mixing function. Thus, the following table describes the preferred implementation depicted in FIGS. 29 and 30:

| Round | Key Generation | Round Key |
|---|---|---|
| 1 | X | Fᵢ |
| 2 | Fⱼ | Fᵢ |
| 3 | Fⱼ | Fⱼ |
| 4 | Fᵢ | Fⱼ |
| 5 | Fᵢ | Fᵢ |

It is appreciated that input into the ciphers and rounds therein described above may comprise preprocessing. Furthermore, output of the ciphers and rounds therein may comprise postprocessing.

It is appreciated that software components of the present invention may, if desired, be implemented in ROM (read only memory) form. The software components may, generally, be implemented in hardware, if desired, using conventional techniques.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

### APPENDIX B

The following are S-boxes S₀ through S₇, as listed in Appendix A.5 of the Serpent Cipher specification (www.ftp.cl.cam.ac.uk/ftp/users/rja14/serpent.pdf):

| | | | | | | | | | | | | | | | | |
|---|---|---|---|---|---|---|---|---|---|---|---|---|---|---|---|---|
| S₀ | 3 | 8 | 15 | 1 | 10 | 6 | 5 | 11 | 14 | 13 | 4 | 2 | 7 | 0 | 9 | 12 |
| S₁ | 15 | 12 | 2 | 7 | 9 | 0 | 5 | 10 | 1 | 11 | 14 | 8 | 6 | 13 | 3 | 4 |
| S₂ | 8 | 6 | 7 | 9 | 3 | 12 | 10 | 15 | 13 | 1 | 14 | 4 | 0 | 11 | 5 | 2 |
| S₃ | 0 | 15 | 11 | 8 | 12 | 9 | 6 | 3 | 13 | 1 | 2 | 4 | 10 | 7 | 5 | 14 |
| S₄ | 1 | 15 | 8 | 3 | 12 | 0 | 11 | 6 | 2 | 5 | 4 | 10 | 9 | 14 | 7 | 13 |
| S₅ | 15 | 5 | 2 | 11 | 4 | 10 | 9 | 12 | 0 | 3 | 14 | 8 | 13 | 6 | 7 | 1 |
| S₆ | 7 | 2 | 12 | 5 | 8 | 4 | 6 | 11 | 14 | 9 | 1 | 15 | 13 | 3 | 10 | 0 |
| S₇ | 1 | 13 | 15 | 0 | 14 | 8 | 2 | 11 | 7 | 4 | 12 | 10 | 9 | 3 | 5 | 6 |

The following are inverse S-boxes InvS₀ through InvS₇, as listed in Appendix A.5 of the Serpent Cipher specification, for use in decryption:

| | | | | | | | | | | | | | | | | |
|---|---|---|---|---|---|---|---|---|---|---|---|---|---|---|---|---|
| InvS₀ | 13 | 3 | 11 | 0 | 10 | 6 | 5 | 12 | 1 | 14 | 4 | 7 | 15 | 9 | 8 | 2 |
| InvS₁ | 5 | 8 | 2 | 14 | 15 | 6 | 12 | 3 | 11 | 4 | 7 | 9 | 1 | 13 | 10 | 0 |
| InvS₂ | 12 | 9 | 15 | 4 | 11 | 14 | 1 | 2 | 0 | 3 | 6 | 13 | 5 | 8 | 10 | 7 |
| InvS₃ | 0 | 9 | 10 | 7 | 11 | 14 | 6 | 13 | 3 | 5 | 12 | 2 | 4 | 8 | 15 | 1 |
| InvS₄ | 5 | 0 | 8 | 3 | 10 | 9 | 7 | 14 | 2 | 12 | 11 | 6 | 4 | 15 | 13 | 1 |
| InvS₅ | 8 | 15 | 2 | 9 | 4 | 1 | 13 | 14 | 11 | 6 | 5 | 3 | 7 | 12 | 10 | 0 |
| InvS₆ | 15 | 10 | 1 | 13 | 5 | 3 | 6 | 0 | 4 | 9 | 14 | 7 | 2 | 12 | 8 | 11 |
| InvS₇ | 3 | 0 | 6 | 13 | 9 | 14 | 15 | 8 | 5 | 12 | 11 | 7 | 10 | 1 | 4 | 2 |

### APPENDIX C

Method and System for Block Cipher Encryption

### BACKGROUND

Many encryption methods are known in the art. Of the known methods, many methods are block methods in which a block of plain text is iteratively altered according to a predefined rule; each such iteration is also known as a “round”.

Many block encryption methods can be viewed as specific cases of Feistel networks, also termed herein “Feistel cipher methods”, or “Feistel-like cipher methods”; a single round of a Feistel cipher method is termed herein a “Feistel cipher round”.

Feistel ciphers are defined in the Handbook of Applied Cryptography (A. Menezes, P. van Oorschot, and S. Vanstone, CRC Press, 1996. The Handbook of Applied Cryptography (HAC) is available on the Internet at www.cacr.math.uwaterloo.ca/hac). The discussion of Feistel ciphers in HAC, on pages 250-259, is incorporated herein by reference.

A Feistel cipher is an iterated block cipher mapping a plaintext (comprising two parts, L₀ and R₀), for t-bit blocks L₀ and R₀, to a ciphertext (Rᵣ and Lᵣ), through an 7-round process where r≧1. For 1≦i≦r, round I maps (Lᵢ₋₁, Rᵢ₋₁) using key Kᵢ to (Lᵢ, Rᵢ) as follows: Lᵢ=Rᵢ₋₁, Rᵢ=Lᵢ₋₁δf(Rᵢ₋₁, Kᵢ), where each subkey Kᵢ is derived from the cipher key K (HAC, page 251).

Those skilled in the art will appreciate that although the definition above is for blocks L₀ and R₀ of equal sizes, equality of the sizes is not mandatory.

Decryption of a Feistel cipher is often achieved using the same r-round process but with subkeys used in reverse order, Kᵣ through K₁.

Types of block ciphers which are cases of Feistel networks include the following well-known methods: DES, Lucifer, FEAL, Khufu, Khafre, LOKI, GOST, CAST, and Blowfish.

Feistel ciphers are also discussed in Applied Cryptography Second Edition (B. Schneier, John Wiley and Sons, Inc., 1996) on pages 347-351. The discussion of Feistel ciphers in Applied Cryptography, Second Edition is hereby incorporated herein by reference.

DES is specified in FIPS 46-3, available on the Internet at: csrc.nist.gov/publications/fips/fips46-3/fips46-3.pdf. FIPS 46-3 is hereby incorporated herein by reference.

FOX: A New Family of Block Ciphers, (Pascal Junod and Serge Vaudenay, Selected Areas in Cryptography 2004: Waterloo, Canada, Aug. 9-10, 2004. Revised papers Lecture Notes in Computer Science. Springer-Verlag.) describes the design of a new family of block ciphers based on a Lai-Massey scheme, named FOX. The main features of the design, besides a very high security level, are a large implementation flexibility on various platforms as well as high performances. In addition, a new design of strong and efficient key-schedule algorithms is proposed. Evidence is provided that FOX is immune to linear and differential cryptanalysis.

How to Construct Pseudorandom Permutations From Pseudorandom Functions (M. Luby and C. Rackoff., SIAM Journal on Computing, 17:2, pp. 373-386, April 1988), describes a method to efficiently construct a pseudorandom invertible permutation generator from a pseudorandom function generator. A practical result described in Luby-Rackoff is that any pseudorandom bit generator can be used to construct a block private key cryptosystem which is secure against chosen plaintext attacks, which is one of the strongest known attacks against a cryptosystem.

The disclosures of all references mentioned above and throughout the present specification, as well as the disclosures of all references mentioned in those references, are hereby incorporated herein by reference.

### SUMMARY

The method of this Appendix seeks to provide an improved encryption method, and in particular an improved encryption method related to Feistel encryption methods. A Feistel-like cipher, described herein, is preferably designed to be easily implemented in hardware and difficult to implement in software.

There is thus provided an improved Feistel-like cipher using a P-box in less than all rounds of the Feistel-like cipher.

The P-box is preferably used in every second round of the Feistel-like cipher.

The Feistel-like cipher preferably uses a full-size key and at least one reduced-size intermediate key, such that a size of the reduced-size intermediate key is chosen so that implementation of the Feistel-like cipher without specialized hardware is inefficient.

The size of the intermediate key in bits is preferably not a power of two (2).

The size of the intermediate key in bits is typically eighty nine (89).

Plaintext inputs are preferably not of equal size.

In accordance with a another preferred embodiment, there is provided a multi-round Feistel-like cipher using a first P-box and a second P-box, such that the first P-box is used on a first half of an input, and the second P-box is used on a second half of the input, after the second half input has been modified in a round of the Feistel-like cipher.

### BRIEF DESCRIPTION OF THE DRAWINGS

The present Appendix will be understood and appreciated more fully from the following detailed description, taken in conjunction with the drawings in which:

FIG. 31 is an illustration of a hardened Feistel-like structure for use with a preferred embodiment of the present invention;

FIG. 32 is an illustration of an alternative preferred embodiment of the hardened Feistel-like structure of FIG. 31;

FIG. 33 is a simplified block diagram of a preferred implementation of a MixKey function of the system of FIG. 31; and

FIG. 34 is a simplified block diagram of a CombParts function of the system of FIG. 31.

### DETAILED DESCRIPTION OF A PREFERRED EMBODIMENT

Reference is now made to FIG. 31, which is an illustration of a hardened Feistel-like structure for use with a preferred embodiment of the present invention. It is appreciated that FIG. 31 provides an illustration of data structures and methods for implementing an encryption network, the illustration being drawn in a format which is well known in the art. Persons skilled in the art will appreciated that, as discussed below with reference to FIG. 34, the data structures and methods of the illustrated encryption network may be implemented in special purpose hardware, in software combined with general purpose hardware, or in any appropriate combination thereof. The system/method described in this Appendix encompasses implementations using any such appropriate implementation.

FIG. 31 depicts two rounds of the hardened Feistel-like structure 2100, it being appreciated that a plurality of rounds comprising more than two rounds is preferred, similarly to the plurality of rounds known in the prior art in the case of Feistel-like networks.

In each round of the hardened Feistel-like structure 2100, two halves of a plaintext, left and right, depicted as L and R, are operated on by a MixKey function 2110 and a CombParts function 2120. A preferred method of operation of the MixKey function 2110 is discussed below with reference to FIG. 33, and a preferred method of operation of the CombParts function 2120 is discussed below with reference to FIG. 34. It is appreciated that in each round, L and R preferably have an identical size of 64 bits. It is appreciated that L and R may be any equal size, and 64 bits is used herein as an example.

It is appreciated that the plurality of rounds may preferably be preceded by preprocessing of L and R. For example L and R may preferably be permuted according to a pre-defined permutation in the same manner the DES block cipher permutes the input before the first round (refer to FIPS 46-3). It is further appreciated that after the plurality of rounds are completed, an encrypted output of the hardened Feistel-like structure 2100 may be post-processed. For example, output may preferably be further permuted according to a pre-defined permutation in the same manner the DES block cipher permutes the state after the 16^{th} round (refer to FIPS 46-3).

In addition, a first round of the hardened Feistel-like structure 2100 and a last round, and other round of the hardened Feistel-like structure 2100 may preferably differ from each other and from other rounds among the plurality of rounds.

After every at least two rounds, L and R are input into a Permutation-box 2130 (P-box). It is appreciated that L and R can be input into the P-box 2130 after every round. However, because of the nature of the Feistel-like structure 2100, such a solution is less secure than a solution where L and R are input into the P-box 2130 every two or more rounds. Those skilled in the art will appreciate that input into the P-box 2130 every round may result in several bits left unchanged for at least two rounds. Therefore, input into the P-box 2130 after two or more rounds is a more secure implementation of the Feistel-like structure 2100.

In some preferred embodiment, R may optionally not be input into the P-box 2130.

P-boxes are well known cryptographic structures. Typically, P-boxes are used to introduce permutations into ciphertext messages. P-box 2130 preferably comprises a bit permutation routine which preferably:
concatenates L and R;
permutes the bits comprising L and R;
produces a result of the permutation; and
splits the result into the next iteration of L and R.

It is appreciated that implementing the P-box 2130 every two rounds makes the Feistel-like structure 2100 harder to implement in software.

In a preferred embodiment, between 20 and 50 rounds are implemented. The exact number of rounds depends on the operation of a function, described with reference to FIG. 33, as the Reduce function.

In one preferred implementation, a 128 bit key (not shown) is preferably used to generate a plurality of round keys 2190, where each round key 2190 is used in one Feistel round. A typical number of rounds is 46. Round key 2190 generation is preferably done through a key expansion algorithm such as the KS128 algorithm (described in “FOX: A New Family of Block Ciphers”, P. Junod and S. Vaudenay, SAC 2004). Each round key 2190 may comprise 100 bits, 146 bits, or any other appropriate bit size.

Reference is now made to FIG. 32, which is an illustration of an alternative preferred embodiment of the hardened Feistel-like structure 2100 of FIG. 31. In the alternative preferred embodiment of the hardened Feistel-like structure 2100 depicted in FIG. 32, the hardened Feistel-like structure 2100 is implemented as in FIG. 31. However, rather than inputting L and R into the P-box 2130 (FIG. 31), the output of the CombParts function 2120 is input into P-box PLᵢ 2160, and Rᵢ is optionally input into P-box PRᵢ 2170. Both PLᵢ 2160 and PRᵢ 2170 are permutations of {1, . . . , 64}.

As had been proven in Luby and Rackoff, (How to Construct Pseudorandom Permutations from Pseudorandom Functions, SIAM Journal on Computing, 17:2, pp. 373-386, April 1988) assuming that the MixKey functions are pseudo-random, Feistel-like structures that employ a XOR operator as the CombParts operator provide pseudo-random functions. Those skilled in the art will appreciate that replacement of the XOR operation with a different CombParts operator will preserve the correctness of the proof. Applying a P-box after every two or more rounds has not yet been proven to be secure.

Reference is now made to FIG. 33, which is a simplified block diagram of a preferred implementation of the MixKey function 2110 of the system of FIG. 31. The MixKey function 2110 preferably integrates the round key 2230 with the 64 bit right half in order to generate a 64 bit input to the CombParts function 2120.

In some preferred embodiments, a plurality of different instances of the MixKey function 2110 are implemented. For example and without limiting the generality of the foregoing, after a first instance of the MixKey function 2110 has been used for several rounds, a second instance of the MixKey function 2110 is used for several rounds, and so forth. As an alternative and non-limiting example of implementing different instances of the MixKey function 2110, instances may be implemented cyclically. For instance, if there are three different instance of the MixKey function 2110, the MixKey function 2110 may be implemented by first using a first instance of the MixKey function 2110, then using a second instance of the MixKey function 2110, and then using a third instance of the MixKey function 2110. After the third instance of the MixKey function 2110 is used, the first instance is used again, and so forth, in a cyclical fashion. It is appreciated that in the previous example three different implementations the MixKey function 2110 were mentioned by way of example, and any other appropriate number of implementations of the MixKey function 2110 may be used.

The MixKey function 2110 preferably comprises three subfunctions:
RExpansion 2210;
CombKey 2220; and
Reduce 2240.

Implementations of the MixKey function 2110 may differ by using different instances of the three subfunctions RExpansion 2210, CombKey 2220, and Reduce 2240.

RExpansion 2210 preferably expands the right half of the plaintext, R to 89 bits. Those skilled in the art will appreciate that outputting 89 bits by RExpansion 2210 is a deliberate choice, in that 89 is not a power of 2. Therefore, encryption and decryption is more difficult in software than in hardware. It is also appreciated that any other size may be used for the size of the output of RExpansion 2210, however, it is preferable that the size be an odd number of bits in order that encryption and decryption without specialized hardware be difficult.

In one preferred embodiment of RExpansion 2210, RExpansion 2210 preferably replicates a predefined set of 25 input bits in order to produce an 89 bit intermediate value. The 89 bit intermediate value is sent to CombKey 2220 for combining with the round key 2230. It is appreciated that in some preferred implementations of RExpansion 2210, the predefined set may be unique per round. In another preferred embodiment of RExpansion 2210, RExpansion 2210 preferably performs an expanding linear transformation on R by performing an exclusive-OR (XOR) on a predefined set of input bits. In yet another preferred embodiment of RExpansion 2210, RExpansion 2210 preferably replicates a predefined set of 25 input bits and permutes, with a XOR, the predefined set of 25 input bits.

In still another preferred embodiment of RExpansion 2210, RExpansion 2210 preferably comprises a sparse linear transformation, such that each output bit is the result of a XOR of two input bits, and each input bit affects one or two output bits.

Preferably, there are a plurality of instances of RExpansion 2210, such that different instances of RExpansion 2210 can be used in different rounds.

CombKey 2220 preferably performs an operation which combines the 89 bit intermediate value with the round key 2230. Any appropriate reversible operation may be used. In some preferred implementations, the size of the round key 2230 is preferably identical to the size of the output of RExpansion 2210, and the combining operation preferably comprises a bitwise XOR. In other preferred implementations the combining operation preferably comprises one of addition and subtraction modulo some constant. CombKey 2220 preferably outputs a result which is preferably input into Reduce 2240.

Reduce 2240 preferably reduces the output of CombKey into a 64 bit result. The reduce function 2240 is preferably designed in such a fashion that the reduce function 2240 is difficult to efficiently implement without specialized hardware, and easy to implement in specialized hardware. The reduce function 2240 preferably comprises a plurality of AND, OR, and NOT gates, arranged in a plurality of layers. After each one of the plurality of layers of gates, a resulting set of bits are preferably permuted and input into a next layer of the plurality of layers of gates.

Furthermore, each output bit is preferably close to balanced. Specifically, the probability that any output bit has a value of 1 is approximately one half, given a uniform distribution of input bits. It is preferable that each output bit is close to balanced even when a small subset of input bits comprise fixed values.

Additionally, each output bit function preferably does not comprise linear approximations. Specifically, for every linear operator L and for each output bit, the probability that a given output bit is identical to the result of applying the operator L on a corresponding input bit, assuming uniform distribution of the input bits, is preferably close to one half.

Preferably, there are a plurality of instances of the reduce function 2240, such that different instances of the reduce function 2240 can be used in different rounds.

It is appreciated that in some preferred implementations of the reduce function 2240, the reduce function 2240 can be one of:

identical for all rounds;

unique for all rounds;

selected differently for even and odd rounds; and

any other appropriate combination of instances of the reduce function 2240.

The reduce function 2240 is preferably implemented comprising 20-50 layers of small functions, each of the small functions serving as building blocks from which the reduce function 2240 is constructed. Each of the small functions preferably employs a balanced function, BF, and a non-linear function, NLF. At a first stage, NLF is preferably executed on at least one of the bits, thereby producing an output, Q. After executing NLF, BF is preferably executed on Q and at least a second input bit.

Non-limiting examples of appropriate small functions processing 3-bit inputs which are appropriate building blocks used in implementations of the reduce function 2240 include:

(input1 OR input2)⊕input3; and

NOT((input1 AND input2)⊕input3).

Implementations of the reduce function 2240 in a second layer preferably takes, as inputs, outputs of the reduce function 2240 in a first layer. It is preferable that a selection of which output of the first layer is input to which reduce function 2240 in the second layer is performed in such a way as to maximize mixing between layers.

In certain preferred implementations of the MixKey 2110, a pool of from 4 to 6 reduce functions 2240 are preferably available. The 4 to 6 reduce functions 2240 are used in a predetermined order, such that in each round only one of the reduce functions 2240 of the pool is used. For instance, and without limiting the generality of the foregoing, if there are 20 rounds and if there are 4 reduce functions 2240, designated as A, B, C, D, reduce function 2240 A may be used during rounds 1-5, reduce function B may be used during rounds 5-10, and so forth. Alternatively reduce function 2240 A may be used during rounds 1, 6, 11, and 16; reduce function 2240 B may be used during rounds 2, 7, 12, and 17; reduce function 2240 C may be used during rounds 3, 8, 13, and 18; reduce function 2240 D may be used during rounds 4, 9, 14, and 19; and reduce function 2240 E may be used during rounds 5, 10, 15, and 20. It is appreciated that any other suitable arrangement of the 4 to 6 reduce functions 2240 is acceptable.

Reference is now made to FIG. 34, which is a simplified block diagram of the CombParts function 2120 of the system of FIG. 31. The CombParts function 2120 preferably combines the 64 bit result of MixKey 2110 with the 64 bit unchanged L, thereby producing a new pseudo-random 64 bit R.

CombParts 2120 is preferably implemented such that:
CombParts 2120 is invertible for a second parameter with respect to a fixed first parameter. Namely, there should be a function ICombParts (inverted CombParts) such that for every X and Y: ICombParts(X, CombParts(X, Y))=Y; and
CombParts should not be an involution; that is, ICombParts preferably differs significantly from CombParts. Specifically, a function such as XOR (such as is implemented in DES) would be unacceptable.

Several preferred implementations of functions which are both invertible for a second parameter with respect to a fixed first parameter and are not an involution are discussed below.

The bit result of MixKey 2110 is preferably input into a splitter 2310. Similarly, the 64 bit unchanged L is input into a splitter 2315. Splitter 2310 and splitter 2315 preferably divide their respective inputs into small sub-blocks, preferably of 2 to 4 bits each in size. In some preferred implementations, splitter 2310 preferably divides the 64 bit result of MixKey 2110 into 16 4-bit sub-blocks, and splitter 2315 preferably divides the 64 bit unchanged L into 16 4-bit sub-blocks.

Each sub-block from splitter 2310 and corresponding sub-block from splitter 2315 is preferably input to one of a plurality of SubComb functions 2320. It is appreciated that in some preferred implementations, there are 16 SubComb 2320 functions, in other preferred implementations, there are 32 SubComb 2320 functions, and in still other preferred implementations, there are some other number of SubComb 2320 functions.

SubComb 2320 is preferably implemented such that:
For every first input, SubComb 2320 is preferably reversible with respect to a second input; and
The distribution of the effect of the input bits from splitter 2315 is preferably maximized in the output to Join function 2330.
Each of the input bits affects a maximal number of output bits. Namely when selecting a random bit; taking a subset of input bits that includes all of the input bits except for the selected bit; selecting random values; and fixing the bits in the subset to the selected random values, the probability that the result of calculating SubComb 2320 for the input bits with the selected bit as ‘1’ is equal to the probability that the result of calculating SubComb 2320 for the input bits with the selected bit as ‘0’, and is close to one half.

In the following discussion of several preferred implementations of SubComb 2320, it is assumed that SubComb 2320 receives two k-bit inputs and one k-bit output. Input bits from MixKey 2110 are referred to hereinafter as data bits, and input bits from L are referred to as control bits. k is preferably a small integer between 2 and 8.

One preferred implementation of SubComb 2320 comprises arithmetically adding a number whose binary representation corresponds to the data bits 2^{k} to a number whose binary representation corresponds to the control bits. It is appreciated that performing the above described arithmetic operation for small k can be efficiently implemented in specialized hardware.

It is appreciated that an inverse function of SubComb 2320 comprises a result of arithmetic subtraction of a number whose binary representation corresponds to the control bits from the number whose binary representation corresponds to the data bits.

A second preferred implementation of SubComb 2320 preferably performs a linear transformation on input bits from MixKey 2110 and input bits from L, generating a 4 bit temporal result. The 4 bit temporal result is then preferably input into a 4-bit-to-4-bit S-box (S-boxes are well known cryptographic structures. See, for example, FIPS 46-3.)

A third preferred implementation of SubComb 2320, comprises the following function:

1. For the first input B1=b11, b12 and for the second input B2=b21, b22, temp=b21, b22.

2. If b11=1, then shift temp by one location, such that temp=b22,b21.

3. If b12=1, then apply a bitwise negation (a “NOT” gate) on temp.

4. Output temp.

It is appreciated that in some preferred embodiments, the second and third preferred implementations of SubComb 2320 are both implemented.

A fourth preferred implementation of SubComb 2320, more appropriate for larger inputs to the SubComb function, for instance, when the inputs are two 4-16 bit vectors, comprises defining a mapping of control input to a domain of invertible linear transformations. For example and without limiting the generality of the foregoing, the mapping may comprise starting with the identity transformation and replacing certain locations with control bits. It appreciated that when the replaced locations are selected over the primary diagonal, the linear transformation remains invertible. For example, for L(B11, B12, B13, B14), use:

| | | | | | |
|---|---|---|---|---|---|
| [ | 1 | B11 | 0 | B14 | ] |
| [ | 0 | 1 | B12 | 0 | ] |
| [ | 0 | 0 | 1 | B13 | ] |
| [ | 0 | 0 | 0 | 1 | ] |

It is appreciated that the output of SubComb 2320 will therefore be an application of the resultant transformation on the second input.

The Join function 2330 is preferably implemented as a concatenation of the output of the plurality of SubComb functions 2320.

In some preferred embodiment, in order to avoid any localization effects which may be induced either by S-boxes, by linear transformation, or by arithmetic addition, output from CombParts 2120 goes through a bitwise permutation (P-box 2130 (FIG. 31)).

It is appreciated that CombParts 2120 makes encryption by the Feistel-like structure 2100 different from decryption by the Feistel-like structure 2100. Thus, for example and without limiting the generality of the foregoing, a decryptor in a consumer device cannot reencrypt decrypted content.

It is appreciated that software components of the present invention may, if desired, be implemented in ROM (read only memory) form. The software components may, generally, be implemented in hardware, if desired, using conventional techniques.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

1-41. (canceled)

42. A block cipher system for encrypting/decrypting a plurality of blocks between plaintext and ciphertext, each of the blocks being associated with a constant root key, the system comprising:
an encryption/decryption key module to determine an input key for each of blocks based on a function having a plurality of inputs including:
the root key and an initialization vector, for a first one of the blocks; and
the plaintext of at least one of the blocks which was previously encrypted/decrypted and the root key, for the blocks other than the first block; and
an encryption/decryption module to encrypt/decrypt each of the blocks based on the respective input key determined for each of the blocks.

43. The system according to claim 42, wherein the input key for the blocks other than the first block is also based on the initialization vector.

44. The system according to claim 42, wherein the input key of each of the blocks other than the first block, is also based on the ciphertext of at least one of the blocks which was previously encrypted/decrypted.

45. The system according to claim 44, wherein the input key of the each of the blocks other than the first block, is also based on the ciphertext of one of the blocks last encrypted/decrypted.

46. The system according to claim 42, wherein the input key of each of the blocks other than the first block, is also based on the plaintext of one of the blocks last encrypted/decrypted.

47. The system according to claim 42, wherein each of the blocks has a block index, the input key of each of the blocks also being based on the block index.

48. The system according to claim 42, wherein the encryption/decryption input key module includes a counter module to maintain a block counter of the number of the blocks processed such that the input key of each of the blocks is also based on the block counter.

49. The system according to claim 42, wherein the input key of each of the blocks is determined using an exclusive-OR function.

50. The system according to claim 42, wherein the input key of each of the blocks is determined using a cryptographic hash function.

51. A block cipher system for encrypting/decrypting a plurality of blocks between plaintext and ciphertext, each of the blocks being associated with a constant root key, the system comprising:
an encryption/decryption module including a plurality of block ciphers to jointly encrypt/decrypt between the plaintext and the ciphertext such that, for each of the blocks, between a first pair of the block ciphers there is a first intermediate value which is a value between the plaintext and the ciphertext, at least one of the ciphers performing encryption/decryption based on an input key; and
an encryption/decryption key module to determine the input key for each of blocks based on a function having a plurality of inputs including:
the root key and an initialization vector, for a first one of the blocks; and
the first intermediate value of a prior one of the blocks and the root key, for the blocks other than the first block.

52. The system according to claim 51, wherein the encryption/decryption module includes at least three block ciphers such that encrypting/decrypting between the plaintext and the ciphertext is performed jointly by the at least three block ciphers.

53. The system according to claim 51, wherein between a second pair of the block ciphers, for each of the blocks, there is a second intermediate value which is a value between the plaintext and the ciphertext, the encryption/decryption key module being operative to determine the input key, for the blocks other than the first block, such that one of the inputs of the function also includes the second intermediate value of a prior one of the blocks.

54. The system according to claim 51, wherein the prior one block is a last prior-processed one of the blocks.

55. The system according to claim 51, wherein each of the blocks has a block index, the input key of each of the blocks also being based on the block index.

56. The system according to claim 51, wherein the encryption/decryption input key module includes a counter module to maintain a block counter of the number of the blocks processed such that the input key of each of the blocks is also based on the block counter.

57. The system according to claim 51, wherein the input key of each of the blocks is determined using an exclusive-OR function.

58. The system according to claim 51, wherein the input key of each of the blocks is determined using a cryptographic hash function.

59. A method for operating a block cipher to encrypt/decrypt a plurality of blocks between plaintext and ciphertext, each of the blocks being associated with a constant root key, the method comprising:
determining an input key for each of blocks based on a function having a plurality of inputs including:
the root key and an initialization vector, for a first one of the blocks; and
the plaintext of at least one of the blocks which was previously encrypted/decrypted and the root key, for the blocks other than the first block; and
encrypting/decrypting each of the blocks based on the respective input key determined for each of the blocks.

60. A method for operating a block cipher to encrypt/decrypt a plurality of blocks between ciphertext and plaintext, each of the packets having a plurality of blocks, the packets being associated with at least one constant root key, the method comprising:
providing a plurality of block ciphers to jointly encrypt/decrypt between the plaintext and the ciphertext such that, for each of the blocks, between a first pair of the block ciphers there is a first intermediate value which is a value between the plaintext and the ciphertext;
determining an input key for each of blocks based on a function having a plurality of inputs including:
the root key and an initialization vector, for a first one of the blocks; and
the first intermediate value of a prior one of the blocks and the root key, for the blocks other than the first block; and
performing encryption/decryption for one of the block ciphers based on the input key.

61. A block cipher system for encrypting/decrypting a plurality of blocks between plaintext and ciphertext, each of the blocks being associated with a constant root key, the system comprising:
means for determining an input key for each of blocks based on a function having a plurality of inputs including:
the root key and an initialization vector, for a first one of the blocks; and
the plaintext of at least one of the blocks which was previously encrypted/decrypted and the root key, for the blocks other than the first block; and
means for encrypting/decrypting each of the blocks based on the respective input key determined for each of the blocks.

62. A block cipher system for encrypting/decrypting a plurality of blocks between plaintext and ciphertext, each of the blocks being associated with a constant root key, the system comprising:
a means for encryption/decryption including a plurality of block ciphers to jointly encrypt/decrypt between the plaintext and the ciphertext such that, for each of the blocks, between a first pair of the block ciphers there is a first intermediate value which is a value between the plaintext and the ciphertext, at least one of the ciphers performing encryption/decryption based on an input key; and
means for determining the input key for each of blocks based on a function having a plurality of inputs including:
the root key and an initialization vector, for a first one of the blocks; and
the first intermediate value of a prior one of the blocks and the root key, for the blocks other than the first block.
